(19) United States
(12) Patent Application Publication
(10) Pub. No.: US 2026/0278439 A1
(43) Pub. Date: Sep. 17, 2026

(54) METHODS AND SYSTEMS FOR QUANTUM OPERATION EXECUTION INCLUDING FLUX FIELD STABILIZATION ENGINE

(71) Applicant: iQore, Inc., Lewes, DE (US)

(72) Inventor: Sean Null, Kansas City, MO (US)

(21) Appl. No.: 19/080,395

(22) Filed: Mar. 14, 2025

(51) Int. Cl. G06N 10/40

(52) U.S. Cl. CPC G06N 10/40

(57) ABSTRACT

A quantum computing system includes a quantum processor including a quantum circuit including qubits, and a qubit flux field stabilization engine. The qubit flux field stabilization engine is configured to model a flux coherence field for each qubit and adjust at least one parameter of the quantum circuit to manipulate an operating status of the qubits based on the flux coherence fields around the qubits to at least one of reduce interference among the flux coherence fields, reduce noise, or reduce power consumption of the quantum processor.

### TECHNICAL FIELD

The field of the disclosure relates generally to quantum computing systems and, more particularly, to quantum computing systems including qubit flux field stabilization engines.

### BACKGROUND

Quantum computing systems utilize quantum physics to provide enhanced computational abilities. For example, quantum computing systems include quantum processors which operate based on units of quantum information such as qubits. Quantum processors provide additional processing capabilities in comparison to processors including binary bits. For example, the qubits are capable of superposition of multiple states which provides more options than the traditional binary bits. As a result, the quantum processors are capable of more complex quantum operations.

Quantum computing systems still need vast improvement to capitalize on their potential. For example, quantum computing systems rely on entanglement and coherence of the qubits to operate. However, qubits are incredibly sensitive to the environment and can have short qubit coherence times due to environmental decoherence. When interacting with the environment, qubits are subject to decoherence due to spontaneous emission, energy relaxation, or fluctuations. In addition, random changes in magnetic flux through the qubit loop (e.g., flux noise) can cause dephasing which is a shifting in the qubit frequency. As a result, the quantum computing systems can have relatively high quantum error rates and require extensive correction methods. At least some current error correction methods rely on external computing systems. Also, the quantum computing systems may include extra or redundant qubits solely to provide error correction. In addition, current quantum computing systems may rely on extensive and complex hardware such as elaborate cooling systems to control the environment of the qubits.

As a result, the quantum computer systems are large and expensive to operate and require vast amounts of hardware. In addition, the quantum computing systems experience significant power consumption due to, for example, cryogenic cooling requirements.

Therefore, there is a need for a quantum computing system that improves performance of the quantum computing systems without adding or increasing complexity of hardware or relying on external error correction.

### BRIEF DESCRIPTION

In one aspect, a quantum processor includes a quantum circuit including qubits and a qubit flux field stabilization engine. The qubit flux field stabilization engine is configured to model a flux coherence field for each qubit and adjust at least one parameter of the quantum circuit based on the flux coherence fields around the qubits to at least one of reduce interference among the flux coherence fields, reduce noise, or reduce power consumption of the quantum processor.

In another aspect, a method of operating a quantum processor includes initializing a quantum circuit of the quantum processor. The quantum circuit includes qubits. The method also includes determining a flux coherence field for each qubit using a qubit flux field stabilization engine. The method further includes adjusting at least one parameter of the quantum circuit based on the flux coherence fields around the qubits to at least one of reduce interference among the flux coherence fields, reduce noise, or reduce power consumption of the processor. The method also includes performing, using the circuit, a quantum operation.

In another aspect, a quantum computing system includes a first quantum processor including a first quantum circuit including first qubits, a second quantum processor including a second quantum circuit including second qubits, and a quantum processor synchronization module. The quantum processor synchronization module is configured to model a first flux coherence field for each first qubit, model a second flux coherence field for each second qubit, and synchronize quantum computing operations of the first quantum processor and the second quantum processor based on the first flux coherence fields and the second flux coherence fields.

In some aspects, a quantum execution framework dynamically adjusts coherence states of qubits using software-driven structured flux field modeling.

In some aspects, a software-driven quantum error suppression module dynamically detects and corrects quantum noise before execution errors propagate.

In some aspects, a quantum execution method enables seamless cross-device synchronization of entangled qubits across multiple quantum processors without requiring hardware interconnects.

In some aspects, a quantum execution process continuously monitors and adjusts coherence stability of qubits to prevent decoherence during execution.

In some aspects, a software-defined process refines quantum phase interactions to maintain entanglement fidelity during quantum executions.

In some aspects, an AI-driven execution framework dynamically reorganizes quantum gate operations in real-time to minimize circuit depth and execution latency.

In some aspects, an AI system detects and suppresses environmental and computational quantum noise during execution.

In some aspects, a quantum execution optimization framework dynamically restructures execution pathways using AI-driven coherence and phase adjustments.

In some aspects, a software-driven execution monitoring system actively stabilizes quantum state coherence during computation.

In some aspects, an AI-enhanced hybrid quantum-classical execution framework dynamically adjusts computational workload distribution between classical and quantum processors.

In some aspects, a software-defined quantum execution framework dynamically adjusts quantum circuit execution based on structured flux energy modeling, flux stabilization, and qubit-induced coherence control.

In some aspects, a software-driven quantum measurement stability system reduces decoherence effects caused by state collapse during final readout operations.

In some aspects, an AI-powered self-calibrating quantum execution system continuously refines quantum circuit parameters based on real-time execution feedback to improve overall stability.

In some aspects, a quantum execution framework directly interacts with at least one quantum computing library to provide quantum state control.

In some aspects, a quantum execution system uses generative AI for real-time coherence stabilization and quantum error suppression without hardware modifications. The quantum execution system is configured to restructure quantum execution dynamically based on structured vacuum energy modeling.

In some aspects, a self-adaptive quantum circuit transpiler restructures quantum execution dynamically based on structured vacuum energy modeling.

In some aspects, a software-defined quantum execution framework provides for multi-platform quantum hardware compatibility without requiring physical modifications to quantum processors.

In some aspects, a quantum execution framework dynamically modifies circuit transpilation and execution pathways via structured vacuum energy modeling and AI-driven error suppression.

In some aspects, a quantum flux field engine that continuously refines qubit execution parameters and gate operations based on real-time feedback from structured vacuum field modeling.

In some aspects, a quantum processor includes a quantum circuit including qubits that are operated according to execution pathways to perform quantum operations. The quantum processor also includes a qubit flux field stabilization engine configured to model flux interactions associated with the execution pathways and/or the qubits; and adjust at least one parameter of the quantum circuit based on the flux interactions to at least one of reduce flux interference, reduce noise, or reduce power consumption of the quantum processor.

In some aspects, a method of operating a quantum processor includes initializing a quantum circuit including qubits that are operated according to execution pathways to perform quantum operations, determining flux interactions associated with the execution pathways and/or the qubits using a qubit flux field stabilization engine, and adjusting at least one parameter of the quantum circuit based on the flux interactions to at least one of reduce interference among the flux coherence fields, reduce noise, or reduce power consumption of the processor; and performing, using the quantum circuit, a quantum operation.

In some aspects, a quantum computing system includes a quantum processor including qubits; and a qubit flux field stabilization engine. The qubit flux field stabilization engine is configured to model a flux coherence field for each qubit; and adjust at least one parameter of the quantum processor based on the flux coherence fields around the qubits to at least one of reduce interference among the flux coherence fields, reduce noise, or reduce power consumption of the quantum processor.

### BRIEF DESCRIPTION OF THE DRAWINGS

FIG. 1 is a partially schematic diagram of an example quantum computing system.

FIG. 2 is a block diagram of an example quantum computing system including a qubit flux field stabilization engine.

FIG. 3 is a partially schematic diagram of a portion of a quantum circuit and an AI execution optimization layer.

FIG. 4 is a flow diagram of an example method of operating a quantum computing system such as the quantum computing system shown in FIGS. 1-3.

FIG. 5 is a schematic diagram of a system architecture of an example quantum computing system.

FIG. 6 is a flow diagram of an example method of operating the quantum computing system architecture shown in FIG. 5.

FIG. 7 is a block diagram of a software-driven quantum execution framework of an example quantum computing system.

FIG. 8 is a flow diagram of an example method of dynamically adjusting a quantum circuit execution to, for example, optimize stability, coherence, and efficiency.

FIG. 9 is a flow diagram of an example quantum error suppression and coherence stabilization module.

FIG. 10 is a block diagram of a system architecture including multiple quantum processors.

FIG. 11 is a flow diagram of a method of operating a quantum circuit using phase distillation and AI-controlled execution pathway optimization.

FIG. 12 is a schematic diagram of a portion of an example quantum circuit.

FIG. 13 is a block diagram of an example integration of a qubit flux field stabilization engine.

The figures depict embodiments for purposes of illustration only. One skilled in the art will readily recognize from the following discussion that other embodiments of the systems and methods illustrated herein may be employed without departing from the scope of the disclosure.

### DETAILED DESCRIPTION

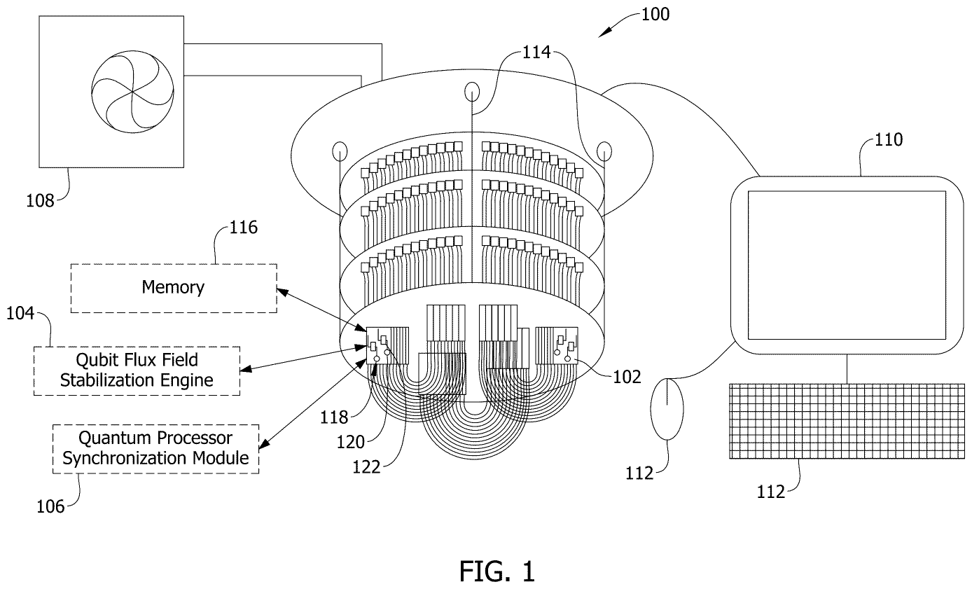

FIG. 1 is a partially schematic diagram of an example quantum computing system, generally indicated at 100. The quantum computing system 100 is configured, for example, to perform quantum operations. The quantum computing system 100 includes quantum processors 102 which enable the quantum computing system 100 to perform quantum operations, a qubit flux field stabilization engine 104, and a quantum processor synchronization module 106. The qubit flux field stabilization engine 104 and the quantum processor synchronization module 106 operate the quantum processors 102 as described below to reduce error rates, increase coherence time, and improve execution speeds when the quantum processors 102 perform operations.

In addition, the quantum computing system 100 may include any other components that facilitate the quantum computing system 100 operating as described. For example, the quantum computing system 100 includes a cooling system 108, a display device 110, an input device 112, structural supports 114, and a memory 116. For example, the input device 112 may include a keyboard, a computer pointer device, a touch screen, a microphone, a camera, and/or any other suitable input device. In addition, the quantum computing system 100 includes at least one timer (not labeled in FIG. 1) that provides timing for execution and synchronization as described herein. The quantum computing system 100 may include more or less components in some examples. For example, the structural supports 114 and/or the cooling system 108 may be minimized, replaced, or omitted, because, in the example, the quantum computing system 100 provides improved performance without need for extensive and complex hardware that requires extensive support or cooling.

The memory 116 may be any type of memory capable of use with the quantum computing system 100. For example, the memory 116 may include a quantum memory and/or a binary memory. For example, the memory 116 may comprise, but is not limited to, quantum memory (e.g., memory configured to store quantum information), volatile storage (e.g., random access memory), non-volatile storage (e.g., read-only memory), flash memory, or any combination of such memories. For example, quantum computing system 100 may also include additional data storage media which may comprise devices (removable and/or non-removable) such as, for example, magnetic disks, optical disks, or tape. The memory 116 may include an operating system and one or more program modules or components suitable for performing the various operations described above. The operating system may be suitable for controlling the operation of the quantum computing system 100. In some examples, a portion of the memory 116 is stored on a database and accessed via a communication network (e.g., cloud storage).

As stated above, a number of program modules and data files may be stored in the memory 116. While executing on the quantum processor 102, the program modules may perform the various processes including, but not limited to, the aspects of quantum computing system 100, as described herein. For example, aspects of the quantum processor synchronization module 106 and/or the qubit flux field stabilization engine 104 are stored on the memory 116 and accessed by the quantum processors 102 when performing quantum operations. The program modules may be incorporated into an operating system, application, middleware, and/or any other program module.

In the example, the quantum computing device includes a plurality of the quantum processors 102 (e.g., a first quantum processor, a second quantum processor, a third quantum processor, etc.). For example, each quantum processor 102 may include one or more processing units, graphics units, communications units, system virtualization units and various application functionality all of which are integrated as a single integrated circuit or incorporated into multiple circuits.

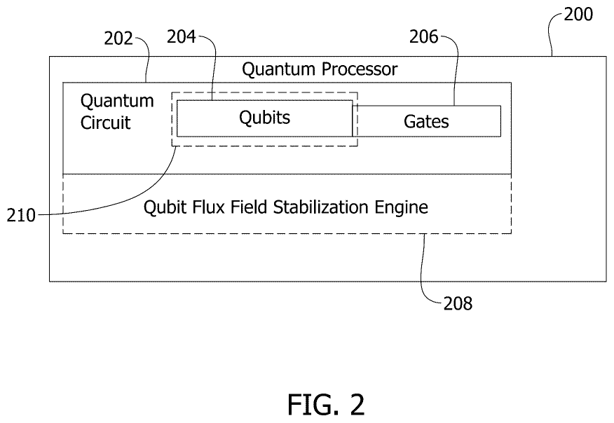

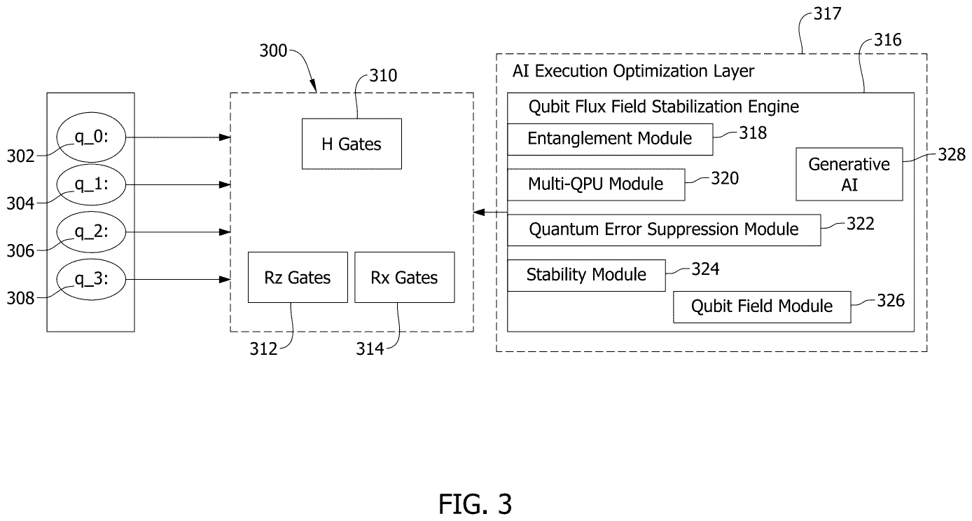

Also, in the example, each quantum processor 102 includes at least one quantum circuit 118 including discrete qubits 120 connected to gates 122. An example quantum processor is illustrated in FIG. 2, and an example quantum circuit is illustrated in FIG. 3. The gates 122 may be any gates suitable for quantum operations. Examples of the gates 122 include, without limitation, CNOT, Tofoli, ancillary, Pauli, and Hadamard gates.

In addition, the qubit flux field stabilization engine 104 includes a software-defined flux energy execution modeling module that operates on the quantum processors 102 and is configured to operate the quantum circuits 118 to model a flux coherence field for each qubit 120. For example, the qubit flux field stabilization engine 104 models flux coherence fields associated with qubits 120 in each quantum processor 102 (e.g., a first flux coherence field for each first qubit in the first processor, a second flux coherence field for each second qubit, a third flux coherence field for each third qubit in the third quantum processor, etc.). The flux coherence field is a virtual field determined by the qubit flux field stabilization engine 104. The flux coherence field for each qubit 120 may be defined by a zone around the qubit 120 bounded by one or more dimensions (e.g., a radius forming a sphere) that is determined based on characteristics of the qubit 120. Interactions within the flux coherence fields of the qubits 120 produce effects on the qubits 120 which can change cohesion, quantum errors, and energy consumption. For example, the flux coherence field may comprise vacuum fluctuations that physically manifest themselves as a cloud of virtual photons (electron dressing) and move with a bare electron. Forces such as the vacuum fluctuations can interact with the environment and affect the qubit and can cause decoherence of the qubit.

Rather than relying on hardware modifications or other methods for static flux-bias calibration, the qubit flux field stabilization engine 104 models the flux coherence fields and facilitates the system accounting for and making dynamic real-time adjustments based on the flux coherence fields and the interactions with the flux coherence fields. For example, the flux coherence fields are determined by equation (1), where Φ_{eff}(t) represents the effective flux experienced by the qubit (incorporating both intrinsic bias and external stabilization), do is the nominal qubit flux bias, and

$${\sum }_{n} {A}_{n} {e}^{- t / {T}_{n}} cos ( {ω}_{n} t + {θ}_{n} )$$

represent external noise sources weighted by AI-driven feedback.

$${Φ}_{eff} ( t ) = {Φ}_{0} + {\sum }_{n} {A}_{n} {e}^{- t / {T}_{n}} cos ( {ω}_{n} t + {θ}_{n} ) \qquad Eq ( 1 )$$

Based on the flux coherence fields, the qubit flux field stabilization engine 104 identifies interactions among qubits 120 and between the qubits 120 and the environment around the qubits 120. For example, quantum fluxes associated with the qubits 120 exhibit resonant behaviors and when interacting with matter or other fields (magnetic fields, vacuum, gravity, etc.) can generate structures within the flux coherence fields. The qubit flux field stabilization engine 104 identifies, structures, and manipulates the flux coherence fields associated with the qubits 120 and interactions with the flux coherence fields to improve performance of the quantum computing system 100. For example, the qubit flux field stabilization engine 104 and the quantum processor synchronization module 106 operate the quantum processors 102 and optimize qubits through structured flux coherence field alignment, advanced error suppression, and multi-QPU synchronization to reduce interference among the flux coherence fields, reduce signal noise, and reduce power consumption of the quantum processors 102.

The qubit flux field stabilization engine 104 acts as a predictive coherence stabilization tool. Instead of just reacting to errors after the errors occur, the qubit flux field stabilization engine 104 models fluctuations in coherence and proactively adjusts operations to prevent decoherence before the decoherence manifests. As a result, the system is able to restructure execution timing dynamically based on predicted coherence loss, minimizing error propagation in real time. For example, a representative function for AI-modeled coherence stabilization is represented by equation (2), where Co is the initial coherence, and Γ(t) is the AI-predicted decoherence function based on training with prior hardware fluctuations.

$$C ( t ) = {C}_{0} {e}^{- Γ ( t )} \qquad Eq ( 2 )$$

Using the predictive modeling, the qubit flux field stabilization engine 104 facilitates execution timing and entanglement distribution remaining optimized across different quantum hardware platforms.

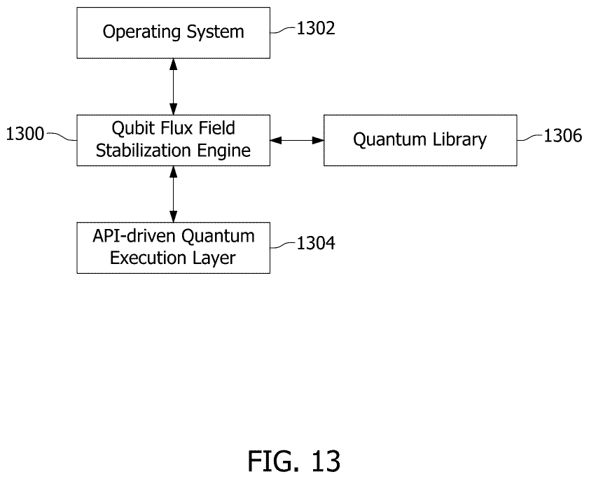

The qubit flux field stabilization engine 104 provides a software-defined quantum execution framework that dynamically optimizes quantum circuit execution by leveraging structured flux energy modeling, flux stabilization, and qubit-induced coherence control. In some examples, at least a portion of the qubit flux field stabilization engine 104 is incorporated into middleware that facilitates communication between an operating system and an application (as shown FIG. 13). For example, the middleware is implemented as a software exception layer that sits between a quantum application layer and a hardware layer. Suitably, the qubit flux field stabilization engine 104 is not bound to physical quantum hardware but is compatible with different hardware to function as a transpilation, optimization, and/or execution enhancement middleware. In other examples, the qubit flux field stabilization engine 104 is incorporated into a standalone application, an operating system, and/or any suitable platform. In some examples, operations of the qubit flux field stabilization engine 104 are divided across middleware and execution level controls and/or are implemented in tightly integrated middleware and execution control packages. In further examples, the qubit flux field stabilization engine 104 is not included in or does not interact with middleware.

During operation, each qubit undergoes an adaptive stability process and flux energy principles are applied to prevent decoherence and entanglement loss. For example, the qubit flux field stabilization engine 104 tracks and predicts interactions between the flux coherence fields of the qubits 120 and the flux coherence fields of other qubits 120, and/or between the flux coherence fields of the qubits 120 and the environment to improve performance of the quantum processors 102. Based on the recorded or predicted interactions, the qubit flux field stabilization engine 104 adjusts operating parameters of the quantum computing system 100 in real time to manipulate (e.g., reduce increase, or otherwise alter) the interactions between the flux coherence fields of the qubits 120 and the flux coherence fields of other qubits 120, and/or between the flux coherence fields of the qubits 120 and the environment. The operating parameters are adjusted to align quantum execution with structured energy fluctuations for enhanced coherence, suppress quantum errors before execution errors propagate, and/or prevent decoherence of the qubits 120. Examples of operating parameters that can be adjusted include, without limitation, coherence states, execution order, gate operations, and entanglement pathways. The adjusted operating parameters provide executions with optimized interactions that improve performance of the quantum processors 102. During quantum operations, the qubit flux field stabilization engine 104 provides at least two functions including 1) reducing drifting of the qubits 120 due to quantum vacuum fluctuations, and 2) preventing distortion of the qubits 120 due to noise.

For example, the qubit flux field stabilization engine 104 dynamically adapts to quantum circuit execution by applying real-time flux corrections based on the quantum state evolution. The qubit flux field stabilization engine 104 continuously monitors coherence fluctuations and adjusts the flux field using adaptive pulse shaping to counteract phase noise and energy decoherence. For example, during operation, the qubit flux field stabilization engine 104 generates an instantaneous flux gradient at every time step. The instantaneous flux gradient may be calculated as a summation of the original or previous flux gradient added to a product of an adaptive energy gradient coefficient and fluctuations in the flux coherence fields (calculated or measured) minus a product of a correction factor for coherence loss and the rate of change of the fluctuation flux gradient.

In some examples, the qubit flux field stabilization engine 104 measures surrounding field gradients before execution to establish a baseline field intensity matrix including representations of flux intensity at each qubit location. The qubit flux field stabilization engine 104 detects phase distortions and/or flux field changes during execution and applies a corrective stabilization coefficient based on a dynamic compensation factor for the detected phase distortions. The corrective stabilization coefficient is multiplied by the sine of the product of the flux oscillation frequency and the time, and the resulting product is added to the baseline field intensity matrix. After execution, any residual decoherence is measured and the qubit flux field stabilization engine 104 applies an adaptive backpropagation update for future executions. Accordingly, in some examples, the qubit flux field stabilization engine 104 determines the baseline correction profile based at least partly on precomputed structured energy models and determines real-time flux measurements to provide dynamic corrections and respond instantly to the environmental noise in real-time.

The qubit flux field stabilization engine 104 detects phase shifts in real-time and generates flux corrections within sub-microsecond latency. As a result, the qubit flux field stabilization engine 104 prevents decoherence before the decoherence propagates and preserves quantum state fidelity without requiring additional logical qubits. In examples, the qubit flux field stabilization engine 104 leverages a precomputed flux coherence field model for each qubit as a baseline and continuously refines predictions using real-time field measurements. In some such examples, the qubit flux field stabilization engine 104 establishes an energy stabilization framework immediately prior to execution, and continuously refines flux values based on evolving coherence conditions to improve execution speed and accuracy.

The qubit flux field stabilization engine 104 models quantum coherence fluctuations by analyzing interactions between qubits and their surrounding energy environment. For example, the qubit flux field stabilization engine 104 utilizes a three-layer predictive framework that integrates fluctuations, quantum state evolution, and adaptive learning mechanisms. In layer one, the qubit flux field stabilization engine 104 models the effect of energy fluctuations on qubit phase stability. For example, the qubit flux field stabilization engine 104 determines coherence decay patterns based on gate sequences. The qubit flux field stabilization engine 104 adjusts or updates, in real-time, the Hamiltonian equation for the quantum operation to account for transient energy shifts. The adjustments may be inferred for each qubit individually or for one or more groups of the qubits. The time dependent coherence losses for each qubit is multiplied by the number of qubits and then summed to obtain a total coherence loss. Then a model of the structured field adjustments is summed to obtain the total field adjustments. The base circuit Hamiltonian is adjusted by the total field adjustments and the total coherence loss to obtain an adaptive Hamiltonian, which is used in the further quantum operations.

Layer two involves a quantum state evolution prediction. The qubit flux field stabilization engine 104 includes an artificial intelligence that trains on historical coherence loss data and uses the historical coherence loss data to predict upcoming phase shifts. Also, the qubit flux field stabilization engine 104 uses a modeling technique such as stochastic Schrödinger equation solver to estimate coherence drift probability based on coherence decay rate and predicted drift onset time.

In layer three, the qubit flux field stabilization engine 104 dynamically adjusts qubit rotation angles before execution to mitigate coherence loss. In addition, the qubit flux field stabilization engine 104 applies filtering such as Kalman filtering to refine error suppression over multiple executions. For example, the qubit flux field stabilization engine 104 adjusts rotation gates by a counter rotation angle to accommodate a predicted phase drift. As a result, the qubit flux field stabilization engine 104 prevents decoherence before the decoherence accumulates in multi-qubit interactions.

In some examples, the qubit flux field stabilization engine 104 is generally hardware agnostic and is compatible with a broad range of computing architectures including superconducting qubit platforms, quantum processing units, and hybrid quantum-classical computing infrastructure. For example, the qubit flux field stabilization engine 104 applies software-driven resonance tuning among other features and, in some examples, adjusts dynamically based on hardware-specific error profiles. For example, the qubit flux field stabilization engine 104 identifies the hardware platform for the quantum operation and determines an error profile that is appropriate for the identified hardware. For superconducting qubit platforms, the qubit flux field stabilization engine 104 may use flux compensation to correct microwave-driven phase shifts. For trapped ion qubits, the qubit flux field stabilization engine 104 adapts to ion heating effects by adjusting laser pulse stability. For photonic qubits, the qubit flux field stabilization engine 104 applies polarization noise filtering to reduce photon loss errors. As such, the qubit flux field stabilization engine 104 is simple and cost-effective to incorporate into or add to existing quantum computing infrastructures.

In examples, at least a portion of the qubit flux field stabilization engine 104 is implemented in different layers and/or components of the quantum computing system 100 or auxiliary systems. For example, the qubit flux field stabilization engine 104 may be implemented in an execution layer that interacts directly with qubits. In one example, the qubit flux field stabilization engine 104 utilizes hardware-embedded execution logic (e.g., field programmable gate arrays, application-specific integrated circuits, etc.) to process quantum instructions. In another example, the qubit flux field stabilization engine 104 is included on a self-contained quantum control unit that pre-processes and optimizes execution without interfacing with external middleware. In some examples, aspects of the qubit flux field stabilization engine 104 are incorporated into an on-chip quantum control system that executes, optimizes, and stabilizes quantum circuits. Such embodiments may operate without interfacing with middleware or requiring input from external sources.

Alternatively, at least some aspects of the qubit flux field stabilization engine 104 are incorporated into offboard sources (e.g., cloud-based systems). For example, aspects of the qubit flux field stabilization engine 104 may utilize cloud-based execution services that process and optimize quantum tasks externally before sending instructions to hardware.

Also, the qubit flux field stabilization engine 104 may rely on networked quantum execution systems in which distributed quantum nodes collaborate in execution without needing middleware coordination. In addition, a protocol for the qubit flux field stabilization engine 104 may optimize and schedule jobs before they reach the quantum processors 102.

In some examples, computer processors utilizing binary bits are configured to implement aspects of the qubit flux field stabilization engine 104 to determine quantum executions before the instructions are sent to the quantum processors 102. In some examples, the computations on the computer processors are enhanced on quantum processors such as using quantum-enhanced classical scheduling to handle gate execution dynamically.

In examples, aspects of the qubit flux field stabilization engine 104 are implemented in various stages of processing and pre-processing qubit operations. For example, the qubit flux field stabilization engine 104 may introduce an error mitigation protocol at the execution level that dynamically corrects noise without needing middleware intervention. Also, the qubit flux field stabilization engine 104 may use real-time coherence tracking built into the execution layer. Further, the qubit flux field stabilization engine 104 may implement flux stabilization techniques controlled directly by the execution layer.

Execution of the quantum computing system 100 may be decentralized across multiple systems. For example, a blockchain-based execution layer may optimize and validate quantum computations in a distributed network. Also, the quantum computing system 100 may utilize peer-to-peer quantum job execution and leverage execution-level consensus mechanisms. In other examples, the quantum computing system 100 creates a tokenized execution framework that assigns quantum tasks dynamically without a centralized system.

The quantum computing system may have a quantum networking stack where execution synchronization occurs in any layers. In other examples, the quantum computing system may have a network or device-based execution system.

The quantum processor synchronization module 106 is configured to synchronize operation of the quantum processors 102. The quantum processor synchronization module 106 dynamically adjusts quantum computations in real time to minimize error accumulation, ensure high-fidelity results across interconnected quantum processing units (QPUs), and deliver increased computational accuracy. The quantum processor synchronization module 106 may be incorporated with the qubit flux field stabilization engine 104 or may be a standalone module capable of operation without the qubit flux field stabilization engine 104.

For example, the quantum processor synchronization module 106 schedules distributed gate operations and entanglement generation and synchronizes clocks and quantum state phases across QPUs (e.g., homogenous or heterogenous QPUs). In addition, the quantum processor synchronization module 106 manages communication and error handling across the QPUs. Also, the quantum processor synchronization module 106 aggregates and merges measurement results into a unified output.

During operation, the quantum processor synchronization module 106 determines or receives the flux coherence fields for each qubit from the qubit flux field stabilization engine 104. The quantum processor synchronization module 106 adjusts operating parameters across two or more of the quantum processors 102 to synchronize quantum computing operations of the quantum processors 102 based on the operating status of the qubits and the flux coherence fields of the quantum processors 102. For example, the quantum processor synchronization module 106 determines execution pathways of the first quantum processor based on interactions between the first flux coherence fields, the second flux coherence fields, and/or the third flux coherence fields. In one example, the quantum processor synchronization module 106 coordinates with the qubit flux field stabilization engine 104 and is configured to synchronize the quantum computing operations of the first, second, third, etc. of the quantum processors 102 based on at least one parameter adjusted by the qubit flux field stabilization engine 104.

The quantum processor synchronization module 106 provides real-time quantum phase alignment and cross-device error prediction to maintain entanglement fidelity across the QPUs. For example, the quantum processor synchronization module 106 determines adaptive phase corrections for dynamic phase matching to ensure that entangled qubits in different QPUs remain synchronized. In addition, the quantum processor synchronization module 106 adjusts entanglement correction factors based on measured decoherence rates to provide noise adaptive fidelity boosting.

In examples, the quantum processor synchronization module 106 uses a distributed noise model for multi-QPU stability. The quantum processor synchronization module 106, using the distributed noise model, identifies inter-device coherence fluctuations, applies probabilistic noise filtering across separate QPUs, and dynamically corrects inter-device timing offsets to prevent decoherence. The quantum computing system 100 including the quantum processor synchronization module 106 provides multi-hardware execution layer that minimizes interconnect latency, dynamically calibrates operations across different qubit modalities, and optimizes entanglement distribution without requiring modifications to the underlying hardware. Moreover, the quantum processor synchronization module 106 is implemented as an adaptive software-driven synchronization framework that actively manages execution timing across different quantum processors.

The quantum computing system 100 may include one or more communication systems that enable communication by and between components of the quantum computing system 100 and/or facilitate or otherwise enable the quantum computing system 100 to communicate with remote computing devices. Examples of suitable communication connections include, but are not limited to, radio frequency (RF) transmitter, receiver, and/or transceiver circuitry, and/or universal serial bus (USB), parallel, and/or serial ports. Communication systems may also comprise physical ports (i.e., ethernet or fiber optic) or wireless antenna and supporting hardware which enable quantum computing system 100 to send or receive data over an internet connection. The communication systems may include a network that is wired and/or wireless and utilizes any suitable communication protocols including, but not limited to, internet, cellular, Wi-Fi, Bluetooth, near-field communication, or other wireless (or wired) communication protocols.

FIG. 2 is a block diagram of an example quantum processor 200 for use with the quantum computing system 100. The quantum processor 200 includes a quantum circuit 202 including qubits 204 and gates 206, and a qubit flux field stabilization engine 208 configured to operate the quantum circuit 202.

Each qubit 204 represents a unit of information for the quantum processor 200. In examples, qubits are electrons, holes, ions, photons, atoms, molecules, artificial atoms, and/or any other atomic or subatomic particle suitable for use in achieving a quantum effect. For example and without limitation, each qubit 204 in the quantum processor 200 is represented by a trapped ion. Each qubit 204 has at least two states. For example and without limitation, the operating status of each qubit 204 can be characterized by directions of electron spin or polarization orientations of a photon. The operating status of the qubits 204 represent computing information and enable the qubits 204 to be used to perform quantum operations. In addition, the qubits 204 each are capable of superposition. Superposition occurs when the qubit 204 has an equal possibility of two or more states. Superposition allows the quantum processor 200 to explore the consequences of both states of the qubit 204 simultaneously and facilitates complex quantum calculations.

Although this disclosure refers to qubits in the examples, a quantum processor could utilize qubits, qutrits, qudits, and/or any units of quantum information. Accordingly, references to qubits in the disclosure and the claims should be considered to cover any units of quantum information, unless stated otherwise.

The quantum processor 200 processes information and performs quantum operations by manipulating the operating status of the qubits. For example, the gates 206 or other components of the quantum processor 200 operate on sets of the qubits 204 to define execution pathways for the qubits 204. The gates 206 provide reversible logic transformations that act on the qubits 204. The gates 206 each can act on one, two, or more of the qubits 204. For example and without limitation, the gates 206 may include microwave systems that emit pulses of microwave radiation. The state of the qubit 204 acted on by one of the gates 206 will switch if the frequency of the microwave matches the resonant frequency of the qubit 204, and/or based on pulse duration or other characteristic of the microwave radiation. In further examples, the gates 206 include lasers, magnetic fields, microwaves, and/or any qubit transformation devices.

The qubit flux field stabilization engine 208 models an optimal virtual flux coherence field around each qubit 204 to ensure stability of the qubit 204 then operates the quantum circuit 202 to manipulate the flux coherence fields 210 around the qubits 204 using, for example, software-defined flux energy execution modeling. The flux coherence field 210 may encompass, for example, a coherent electromagnetic field around the qubit 204. The flux coherence fields are structured by optimizing electromagnetic and other interactions between the qubits 204 and the surrounding energy fields during quantum operations.

In addition, the qubit flux field stabilization engine 208 manipulates the flux coherence fields 210 in real time by dynamically tuning, for example, the timing and phase of the gates 206 to compensate for energy fluctuations. The flux coherence field 210 remains structured during quantum operations and prevents distortion due to the operations of the qubit flux field stabilization engine 208.

For example, the qubit flux field stabilization engine 208 is configured to selectively control the gates 206 based on the flux coherence fields 210 around the qubits 204 to modulate the qubits 204. Also, the qubit flux field stabilization engine 208 is configured to determine a timing of the gates 206 that act on each qubit 204 to reduce interference between the flux coherence fields 210 of the qubits. The reorganization of the gates 206 and precise timing adjustments based on the flux coherence fields 210 cause controlled changes in how the qubits 204 interact with the surrounding energy fields.

In some examples, the qubit flux field stabilization engine 208 determines an operating status of each qubit 204 or a predicted operating status of each qubit 204. The qubit flux field stabilization engine 208 then operates the quantum processor 200 to manipulate the flux coherence fields 210 based on the operating status of the qubits 204 or the predicted operating status of the qubits 204. For example, the operating status of the qubits or the predicted operating status of the qubits may relate to at least one of a decoherence, a quantum error rate, or quantum noise. The qubit flux field stabilization engine 208 determines an operating parameter of the quantum processor 200 based on the flux coherence fields and the operating status of the qubits 204 or the predicted operating status of the qubits 204 to at least one of reduce interference among the flux coherence fields, reduce noise, or reduce power consumption of the quantum processor 200. In the example, the qubit flux field stabilization engine is configured to modify an execution pathway of the quantum circuit 202 to stabilize interactions with the flux coherence field for each qubit 204.

The qubit flux field stabilization engine 208 includes a generative artificial intelligence (AI) that is configured to determine operating parameters of the quantum processor in real-time to further improve performance of the quantum processor 200. The generative artificial intelligence actively modifies execution pathways in real-time. For example, the qubit flux field stabilization engine 208 is configured to predict a potential quantum error and adjust at least one operating parameter of the quantum processor 200 to reduce the opportunity for the quantum error to occur. The generative artificial intelligence may run simulations to predict the quantum error and determine the best way to reduce the error based on the flux coherence fields 210 of the qubits 204. In addition, the qubit flux field stabilization engine 208, using in some examples the generative artificial intelligence, is configured to predict decoherence of at least one qubit 204 in real-time based on fluctuations in the flux coherence fields 210 and adjust the operating parameters of the quantum circuit 202 based on the predicted decoherence to reduce the opportunity for the decoherence to occur. The fluctuations in the flux coherence fields 210 may be, for example, caused by changes in an operating status of the qubit 204 or the direct environment around the qubit 204 based on interactions in the flux coherence fields 210.

The generative artificial intelligence of the qubit flux field stabilization engine 208 facilitates the qubit flux field stabilization engine 208 dynamically adjusting the quantum processor 200 in real time to improve performance. For example, the generative artificial intelligence provides optimized quantum circuit execution by guiding the restructuring of the gates 206 to minimize circuit depth and reduce execution latency. The generative artificial intelligence determines AI-driven execution logic via modeled flux coherence fields to dynamically improve performance. In addition, the qubit flux field stabilization engine 208 provides an AI-powered self-calibrating quantum execution system that continuously refines quantum circuit parameters based on real-time execution feedback to improve overall stability. As a result, the qubit flux field stabilization engine 208 enables circuits 202 to execute faster while maintaining an increased accuracy. In addition, the qubit flux field stabilization engine 208 selects gates that maintain structured entanglement during operation and, thereby, increase coherence time.

Also, in examples, the qubit flux field stabilization engine 208 minimizes decoherence effects caused by state collapse during final readout operations. For example, the generative artificial intelligence models the measurement process and determines how measurements will affect the state stability of the qubits. The generative artificial intelligence predicts or records measurement-induced state stability issues and determines executions during measurement and readout that correct or prevent the stability issues in real-time based on the models. As a result, the qubit flux field stabilization engine 208 facilitates measurement-induced stability of the qubits.

In addition, the qubit flux field stabilization engine 208 provides state evolution mapping in which the compiler determines and controls state transitions of the qubits 204 using software-based modeling instead of letting the quantum states evolve randomly under noise. As a result, the qubit flux field stabilization engine 208 prevents quantum information from “leaking” due to vacuum instability.

In some examples, the qubit flux field stabilization engine 208 includes a compiler that analyzes the circuits 202 to implement aspects of the qubit flux field stabilization engine 208. For example, the compiler identifies opportunities to cancel out rotations or to commute the gates 206 in a way that clusters idle periods for the qubits 204. By clustering idle times, the qubit flux field stabilization engine 208 can schedule protective measures (e.g., dynamic decoupling or bias adjustments) during the intervals to reduce errors and/or stabilize the qubits 204. In addition, the compiler maps the qubits 204 to physical locations based on noise or flux parameters at the physical location. For example, on a superconducting processor, qubits 204 at the edges of a chip may experience less interference from cross-talk, and the qubits 204 located near a cavity in the chip may be protected from interference. The compiler uses calibration data and determines noise spectra of each physical qubit location. The compiler maps logical qubits 204 with heavy workloads to the locations of the qubits 204 that fit best based on the noise profile at the physical locations. The compiler may work across a single processor, or across multiple processors in a multi-QPU system. In the multi-QPU system, the compiler maps the qubits 204 to locations in the logic based on considerations such as entanglement cost between modules, local gate fidelity, and/or the noise profiles at physical locations on different processors.

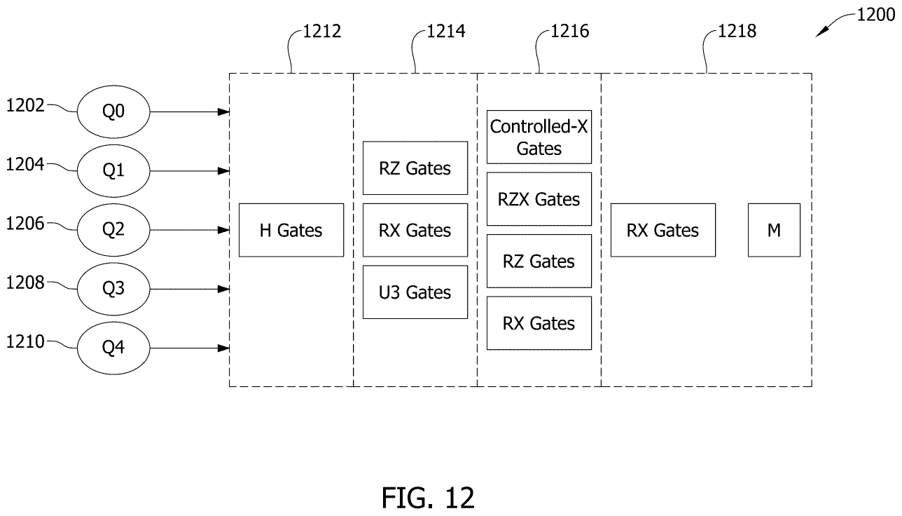

The compiler outputs a circuit such as the circuit shown in FIG. 3 or FIG. 12. In some examples, the compiler outputs annotations or directives that are interpreted by other layers of the qubit flux field stabilization engine 208 and implemented during operation of the quantum computer.

In examples, the compiler is at least partly within the execution layer, within middleware layers, and/or is within any operating layer. For example, the compiler may be an execution-level compiler that pre-processes quantum circuits before running them on hardware and uses a real-time circuit adaptation engine that translates high-level quantum programs directly into hardware-native instructions.

FIG. 3 is a partially schematic diagram of a portion of an example quantum processor including a quantum circuit 300. The quantum circuit 300 includes qubits 302, 304, 306, and 308 arranged along the circuit 300. In the example, the quantum circuit 300 includes four qubits 302, 304, 306, and 308. In other examples, the quantum circuit 300 can include more or less than four of the qubits 302, 304, 306, and 308.

The qubits 302, 304, 306, and 308 are acted on by gates such as Hadamard gates 310. The Hadamard gates 310 facilitate state changes of the qubits 302, 304, 306, and 308 and cause the qubits 302, 304, 306, and 308 to switch to superposition.

In addition, the quantum circuit 300 includes positional gates 312, 314. The positional gates include a rotation operator gate 312 (e.g., a CNOT gate) to control rotation of the qubits 302, 304, 306, and 308, and diagonal and rotation operator gates 314 (e.g., controlled-Z gates) that control rotation and/or linear movement of the qubits 302, 304, 306, and 308. In other examples, the quantum circuit 300 may include other gates without departing from some aspects of the disclosure. In some examples, the gates 310, the gates 312, and/or the gates 314 may be omitted. In other example, the circuit 300 includes universal single-qubit rotation gates or any other suitable gates.

While not necessarily shown in the FIG. 3, the quantum circuit 300 may also include resistors, capacitors, and/or any other circuit components.

A qubit flux field stabilization engine 316 is configured to interact with the quantum circuit 300. The qubit flux field stabilization engine 316 includes an entanglement module 318, a multi-quantum processing unit (QPU) module 320, a quantum error suppression module 322, and a stability module 324. The qubit flux field stabilization engine 316 is configured to operate the quantum circuit 300 and facilitate quantum operations. In the example, an AI execution optimization layer 317 encompasses the entanglement module 318, the multi-quantum processing unit (QPU) module 320, the quantum error suppression module 322, and the stability module 324. The AI execution optimization layer 317 actively modifies execution pathways in real-time based on modeling generated by generative artificial intelligence. In some examples, the AI execution optimization layer 317 includes a feedback loop to provide continual or incremental quantum coherence adjustments.

The qubit flux field stabilization engine 316 includes a qubit flux field module 326 that determines the flux coherence fields for the qubits 302, 304, 306, and 308. For example, the qubit flux field module 326 determines interactions or potential interactions between the qubits 302, 304, 306, and 308 and/or surrounding energy fields and the qubit flux field stabilization engine 316 operates the quantum circuit 300 to manipulate the interactions. In addition, the qubit flux field module 326 sends or otherwise provides the determined flux coherence fields to the entanglement module 318, the multi-QPU module 320, the quantum error suppression module 322, and/or the stability module 324.

The entanglement module 318 ensures that the qubits 302, 304, 306, and 308 achieve and maintain entanglement. The entanglement module 318 monitors the entanglement states of the qubits 302, 304, 306, and 308 and reinforces the long-term stability of the entanglement states to prevent coherence loss. For example, the entanglement module 318 operates the gates 310, 312, 314 to create correlations between the qubits 302, 304, 306, and 308 and link the quantum states together. Moreover, the entanglement module 318 determines operating parameters based on the flux coherence fields of the qubits 302, 304, 306, and 308 to facilitate improved entanglement and reduce decoherence.

The multi-QPU module 320 facilitates the quantum circuit 300 interacting with other quantum circuits and/or quantum processors. In some examples, the multi-QPU module 320 provides qubit load balancing across the quantum circuits and/or quantum processors. The multi-QPU module 320 may be a part of or incorporate the quantum processor synchronization module 106 shown in FIG. 1. The multi-QPU module 320 receives the flux coherence fields of the qubits 302, 304, 306, and 308 and the flux coherence fields of qubits on other processors and determines interactions and modulations that manipulate interactions of the flux coherence fields to synchronize operations across multiple processors including quantum circuits 300. For example, some of the qubits 302, 304, 306, or 308 may be located on separate quantum processors. The multi-QPU module 320 ensures seamless cross-device entanglement across the separate quantum processors. In some examples, the quantum circuit 300 is not connected to other processors and the multi-QPU module 320 may be omitted.

The quantum error suppression module 322 monitors the operating status of the qubits 302, 304, 306, and 308 to identify potential for phase errors. The quantum error suppression module 322 determines operating parameters to accommodate the operating status of the qubits 302, 304, 306, and 308 and suppress any potential error. The quantum error suppression module 322 operates in real-time and dynamically adjusts operating parameters to suppress the errors before the execution of the circuit 300. Moreover, the quantum error suppression module 322 may be located entirely onboard the quantum processor or quantum computing system. Accordingly, the system is not dependent on offboard error correction. In some examples, the quantum error suppression module 322 provides flux-based error suppression. For example, the quantum error suppression module 322 identifies potential errors induced by flux of the qubits 302, 304, 306, and 308 and/or determines corrections for errors based on the flux of the qubits 302, 304, 306, and 308. As a result, the quantum error suppression module 322 optimizes quantum volume and suppresses error accumulation dynamically via structured flux coherence modeling. The quantum circuit 300 has an increased quantum capacity in comparison to other quantum circuits.

The stability module 324 determines operating parameters of the quantum circuit 300 that facilitate stability of the qubits 302, 304, 306, and 308 and/or reduce errors. For example, the stability module 324 causes the qubits 302, 304, 306, and 308 to start in a flux-aligned stable state and prevents decoherence of the qubits 302, 304, 306, and 308. In some examples, the entanglement module 318 determines operating parameters of the quantum circuit 300 to reduce the likelihood of instability and facilitates improved performance of the quantum circuit 300.

The qubit flux field stabilization engine 316 utilizes generative artificial intelligence 328 that facilitates the qubit flux field stabilization engine 316 determining and adjusting parameters of the quantum circuit 300 in real-time based on the flux coherence fields. For example, the generative artificial intelligence 328 runs simulations based on the flux coherence fields and the possible operations of the quantum circuit to predict interactions that cause decoherence, disentanglement, and/or errors. The qubit flux field stabilization engine 316 determines operating parameters that synchronize the timing and operation of the gates 310, 312, 314 to reduce the likelihood of decoherence, disentanglement, and/or errors and improve performance of the quantum circuit 300.

During operation, the quantum circuit 300 receives a command for a quantum computational operation. The computational operation includes a series of gate operations and timing that define execution pathways for the qubits for performing the quantum computational operation. The entanglement module 318 evaluates entanglement to determine if adjustments are required based on the entanglement. The multi-QPU module 320 evaluates the interactions across multiple processors performing the quantum computational operation or other quantum computational operations and determines if adjustments can be made to synchronize the quantum circuits 300. The qubit flux field module 326 determines flux coherence fields for each qubit and evaluates predicted interactions that will occur within the flux coherence fields based on projected execution pathways and adjusts the execution pathways to manipulate the interactions. In some examples, the qubit flux field module 326 models flux interactions for each qubit without defining a specific field around each qubit. For example, the qubit flux field module 326 may determine a generic flux profile that applies to the qubits and determine interactions based on the profiles. Alternatively, the qubit flux field module 326 may store and retrieve information representing standard flux interactions associated with specific quantum operations on execution pathways and insert the information into the model to determine the interactions. In such examples, the qubit flux field module 326 may sacrifice some precision and performance improvement capability to provide simplified calculations.

The qubit flux field stabilization engine 316 projects execution pathways for the qubits 302, 304, 306, and 308. The execution pathways include operations of the Hadamard gates 310, the gates 312, and/or the gates 314 and cause the flux coherence fields of at least some of the qubits 302, 304, 306, and 308 to intersect with each other. The qubit flux field stabilization engine 316 recognizes the identified intersections and determines if the intersections would result in unwanted or inefficient interactions between the qubits 302, 304, 306, and 308. For example, the interactions can cause decoherence or instability of at least one of the qubits 302, 304, 306, and 308, may introduce opportunity for quantum errors, and/or may slow down the quantum processing operations.

If the qubit flux field stabilization engine 316 determines that the interactions are undesired or sub-optimal, the qubit flux field stabilization engine 316 adjusts the timing and/or operation of the Hadamard gates 310, the gates 312, and/or the gates 314 to prevent or manipulate the interactions of the determined flux coherence fields of the qubits 302, 304, 306, and 308. The qubit flux field stabilization engine 316 provides modified execution pathways based on the adjustments to the timing and/or operation of the Hadamard gates 310, the gates 312, and/or the gates 314. The quantum circuit 300 performs the quantum operations using the modified execution pathways. As a result, the quantum circuit 300 improves performance of the quantum circuit 300.

In one example, when a request for a quantum computation is received, the qubits 302, 304, 306, and 308 are initialized in superposition states based on the computation requirements. The qubit flux field stabilization engine 316 applies a structured alignment of the flux coherence fields of the qubits 302, 304, 306, and 308 to stabilize the initial quantum states. The qubit flux field stabilization engine 316 adjusts operating parameters to ensure each qubit 302, 304, 306, and 308 starts with minimal initial decoherence. Also, the stability module 324 of the qubit flux field stabilization engine 316 adjusts operating parameters based on characteristics of the qubits 302, 304, 306, and 308 to ensure that the qubits 302, 304, 306, and 308 initiate in a low-noise, stable, and flux-aligned state. Further, the stability module 324 adjusts frequencies of the qubits 302, 304, 306, and 308 to prevent early phase drift.

After initialization, the gates 310, 312, 314 are applied to the qubits 302, 304, 306, and 308. The timing and the ordering of the gates 310, 312, 314 are dynamically optimized to maximize coherence. In real-time and during operation, the quantum error suppression module 322 detects fluctuations in wavefunction stability and corrects minor phase deviations of the qubits 302, 304, 306, and 308. The structured energy alignment of the flux coherence fields reduces energy leakage from interactions of the qubits 302, 304, 306, and 308 during executions. Also, the quantum error suppression module 322 minimizes gate-induced noise and reduces the need for additional error-correcting qubits.

If the qubits 302, 304, 306, and 308 are split across multiple quantum processors, the multi-QPU module 320 ensures seamless execution across the processors and dynamically synchronizes inter-device quantum communication without loss of entanglement.

During continuing executions, entanglement operations are executed on the qubits 302, 304, 306, and 308 by the gates 312, 314 (CNOT, CZ gates) which could induce entanglement fidelity degradation over time. The entanglement module 318 facilitates maintaining long-term coherence by counteracting normal entanglement fidelity degradation over time. For example, the entanglement module 318 realigns phase interactions and applies structured flux field coherence to reduce entanglement loss. As a result, the entanglement module 318 maintains strong entanglement and/or cross-entanglement between the qubits 302, 304, 306, and 308. In addition, the entanglement module 318 compensates for decoherence over time and extends the usable entanglement window of the qubits 302, 304, 306, and 308 for computational tasks.

The quantum circuit 300 generates a final measurement and readout optimization when the quantum computations are complete. The qubits 302, 304, 306, and 308 are measured for data extraction. The qubit flux field stabilization engine 316 optimizes the measurement process to prevent collapse of the quantum states, prevent errors due to collapse of the quantum states, and generate an accurate translation of quantum results into a readable data format. For example, before measurement, the stability module 324 applies final coherence corrections to reduce measurement noise, and the quantum error suppression module 322 adjusts phase misalignments before quantum collapse occurs. As a result, readout data from the qubits 302, 304, 306, and 308 is extracted with minimal loss or state distortion.

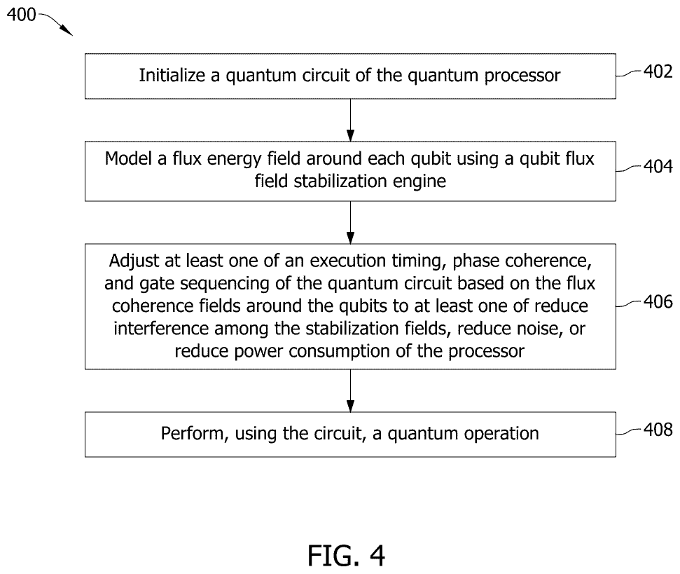

FIG. 4 is a flow diagram of an example method 400 of operating a quantum processor (e.g., the quantum processor 200 shown in FIG. 2) of a quantum computing system (e.g., the quantum computing system 100 shown in FIG. 1). Referring to FIGS. 1-4, the method 400 includes initializing 402 a quantum circuit (e.g., the quantum circuit 300) of the quantum processor. For example, the qubits are initialized in superposition states based on the requirements for the quantum computation.

The method 400 includes modeling 404 a flux coherence field for each qubit using a qubit flux field stabilization engine (e.g., the qubit flux field stabilization engine 104) connected to the quantum circuit. The flux coherence fields are determined and structured to stabilize the initial quantum states of the qubits. For example, the qubit flux field stabilization engine utilizes a computational model that simulates structured flux coherence fields without physical qubit modification. Based on the model, the qubit flux field stabilization engine adjusts qubit frequencies to prevent early phase drift and/or the qubit flux field stabilization engine provides adjustments such that each qubit starts with minimal initial decoherence. In addition, the qubit flux field stabilization engine facilitates the qubits initializing in a low-noise, stable, and flux-aligned state.

The method also includes adjusting 406 at least one parameter of the quantum circuit (e.g., at least one of an execution timing, phase coherence, and gate sequencing of the quantum circuit) based on the flux coherence fields around the qubits to at least one of reduce interference among the flux coherence fields, reduce noise, or reduce power consumption of the processor. For example, the qubit flux field stabilization engine determines interactions between the flux coherence fields around the qubits and modifies an execution pathway of the quantum circuit to stabilize the interactions. The qubit flux field stabilization engine selectively controls quantum gates that perform transformations on the qubits based on the flux coherence fields around the qubits and adjusts a timing of gates for each qubit to reduce interference between the flux coherence fields of the qubits. In some examples, the qubit flux field stabilization engine operates the quantum circuit to deliver adjustments to one or more of the flux coherence fields.

In some examples, the qubit flux field stabilization engine determines an operating status of the qubit or a predicted operating status of the qubit, and adjusts at least one operating parameter of the quantum circuit based on the state of the qubit or the predicted state of the qubit. For example, the state of the qubits or the predicted state of the qubits relates to at least one of a decoherence, a quantum error rate, or quantum noise. The qubit flux field stabilization engine predicts decoherence of at least one qubit in real-time based on fluctuations in the flux coherence fields and modulates the flux coherence fields based on the predicted decoherence to reduce the opportunity for the decoherence to occur.

The method includes performing 408, using the circuit, a quantum operation. The qubit flux field stabilization engine facilitates the quantum operation and ensures that the qubits are operating efficiently while performing the quantum operation. For example, the qubit flux field stabilization engine determines execution pathways that perform the quantum operation and maintain the flux coherence fields and desired interactions within the flux coherence fields to reduce error rates, increase coherence time, and improve execution speeds when the quantum circuit performs the quantum operations.

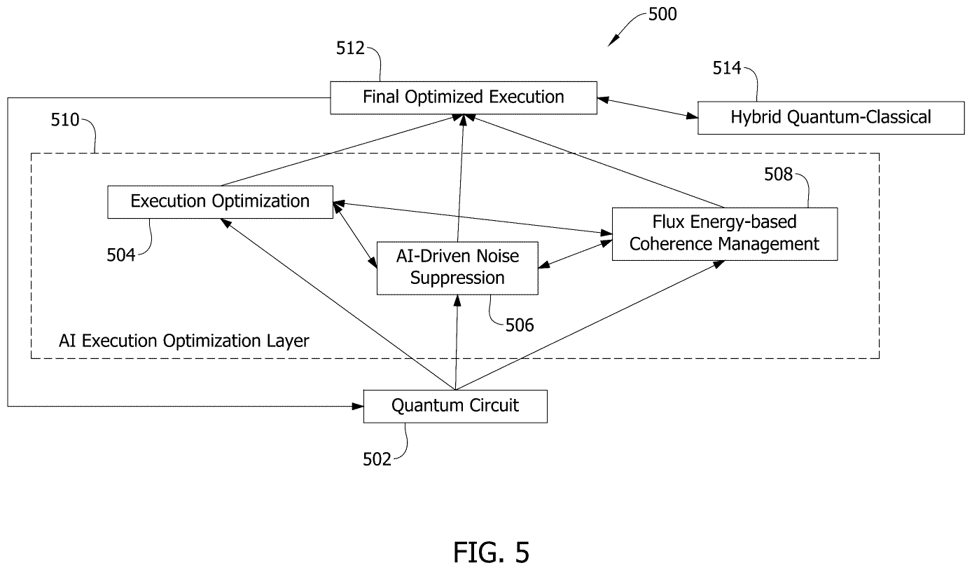

FIG. 5 is a schematic diagram of a system architecture 500 of an example quantum computing system. The system architecture 500 includes a quantum circuit 502 that performs quantum operations. In addition, the system architecture 500 includes an AI execution optimization layer 510 including an execution optimization module 504, an AI-driven noise suppression module 506, and a flux energy-based coherence management module 508.

The AI execution optimization layer 510 is adaptable for different platforms or uses. For example, the AI execution optimization layer 510 can be implemented with a central processing unit (CPU) or a graphics processing unit (GPU) in an execution layer. When operating on a local system or workstation, the AI execution optimization layer 510 executes within the operating system (OS) kernel or user space and leverages, for example, CUDA-enabled GPUs (if available) for accelerated quantum-classical processing. The AI execution optimization layer 510 operates as a software programming language package, optionally based on a software development kit, on the workstation. The AI execution optimization layer 510 optimizes the quantum circuits before the quantum circuits are executed on the quantum processor.

When deployed to existing quantum computing platforms that utilize the cloud, the AI execution optimization layer 510 operates within the execution runtime environment provided by cloud services. The AI execution optimization layer 510 intercepts and optimizes quantum circuit executions before the executions reach the hardware backend. The AI execution optimization layer 510 connects into quantum API services and applies runtime optimizations to minimize noise and increase quantum state fidelity.

When operating directly on hardware of a quantum computing unit, the AI execution optimization layer 510 operates between the quantum program and the backend execution service. The AI execution optimization layer 510 applies transpilation optimizations, error suppression, coherence tracking, and gate-level adjustments and may be integrated into the quantum computing system through APIs, for example. The AI execution optimization layer 510 intercepts the quantum instructions before execution and reconfigures the instructions for improved performance.

In some examples, the AI execution optimization layer 510 may operate on a dedicated quantum processor, a dual purpose quantum processor and/or a classical processor integrated into the quantum computing unit. In such examples, the AI execution optimization layer 510 is directly implemented within the quantum-classical hybrid execution framework and facilitates pre-processing and post-processing of quantum data occurring efficiently.

In an example, the AI execution optimization layer 510 is at least partly deployed in a middleware stack and interacts with APIs and an operating system. The middleware stack intercepts and optimizes execution instructions for the quantum circuit 502 before the execution instructions are delivered to the operating system.

During operation, the modules of the AI execution optimization layer 510 communicate with or operate on the quantum circuit 502 to optimize and control operation of the quantum circuit 502. For example, the execution optimization module 504 determines optimal execution pathways for performing quantum operations. As part of the execution pathways, the execution optimization module 504 determines timing and execution of gates for transforming qubits during performance of quantum operations.

The AI-driven noise suppression module 506 identifies potential noise for the qubits of the quantum circuit. For example, the noise includes vacuum related noise in the vacuum-controlled environment of the qubits. In addition, using generative artificial intelligence (AI), the AI-driven noise suppression module 506 determines executions to suppress or prevent the noise during the quantum operations. For example, the AI-driven noise suppression module 506 may determine flux interactions that cause noise and determine executions to manipulate the interactions and minimize the noise. In addition or alternatively, the AI-driven noise suppression module 506 identifies vacuum noise and determines counteractions to offset or cancel the vacuum noise.

The flux energy-based coherence management module 508 identifies potential decoherence of the qubits of the quantum circuit and, based on the flux coherence fields of the qubits, determines executions to suppress or prevent decoherence. For example, the flux energy-based coherence management module 508 may determine flux interactions that have potential to induce decoherence and the flux energy-based coherence management module 508 determines executions that manipulate the interactions and reduce the opportunity for decoherence of the qubits to occur.

The execution optimization module 504, the AI-driven noise suppression module 506, and the flux energy-based coherence management module 508 are part of an AI execution optimization layer 510, which uses generative artificial intelligence to provide AI-driven execution restructuring. The AI execution optimization layer 510 may be incorporated into a computer application, middleware, and/or an operating system. In one example, the AI execution optimization layer 510 is a middleware execution layer that provides an interface between computer applications, an operating system, another execution layer, and/or any suitable platform. For example, the AI execution optimization layer 510 may be incorporated into an application programming interface (API). In some examples, the AI execution optimization layer 510 communicates directly with quantum computing libraries to enable optimized software-defined quantum state control.

Optionally, the architecture 500 incorporates some components of a bit-based or other non-quantum computing system (e.g., a classical computing system) and the architecture 500 includes a hybrid quantum-classical interface 514. The hybrid quantum-classical interface 514 determines processes for the non-quantum computing processors based on classical computing methods and determines the execution pathways for the quantum circuit 502 using the described quantum principles.

The executions from the flux energy-based coherence management module 508, the AI-driven noise suppression module 506, the execution optimization module 504, and, if included, the hybrid quantum-classical interface 514 are combined into a final optimized execution 512. The final optimized execution 512 provides precise timing and operation of gates to transform qubits and perform desired quantum operations quicker and with a reduced error rate.

Suitably, the architecture 500 determines the circuit depth and adjusts the execution to ensure the circuit depth is within a predetermined range. The circuit depth is selected to provide execution stability. For example, the circuit depth may be less than 100 steps, less than 10 steps, or in a range of 9 to 10 steps. The architecture 500 outputs the final optimized execution 512 if the circuit depth is within the predetermined range. The architecture 500 determines a new execution path based on any of the described methods to optimize circuit execution paths if the circuit depth is outside the predetermined range. In operation, the architecture 500 constrains circuit depth by optimizing entanglement gate placement and adapting the transpilation of the circuit. For example, to optimize gates, the architecture eliminates redundant gate operations and/or applies direct phase alignment in place of extra two-qubit gates. In some examples, the architecture 500 applies a latency control formula to ensure coherence is at least 99% and the circuit depth is within the selected range. Accordingly, the architecture 500 dynamically maintains circuit depth within predefined execution parameters to optimize coherence and performance.

The final optimized execution 512 is determined in real-time. For example, the execution optimization module 504, the AI-driven noise suppression module 506, and the flux energy-based coherence management module 508 are continually updated and modified as needed to provide improved performance during the quantum operations. Moreover, the architecture 500 may continually learn and adapt to refine the execution optimization module 504, the AI-driven noise suppression module 506, and the flux energy-based coherence management module 508 during the quantum operations. In addition, the final optimized execution 512 is provided back to the quantum circuit input in a continuous feedback loop as data flows through the architecture 500 during operation for real-time adjustments.

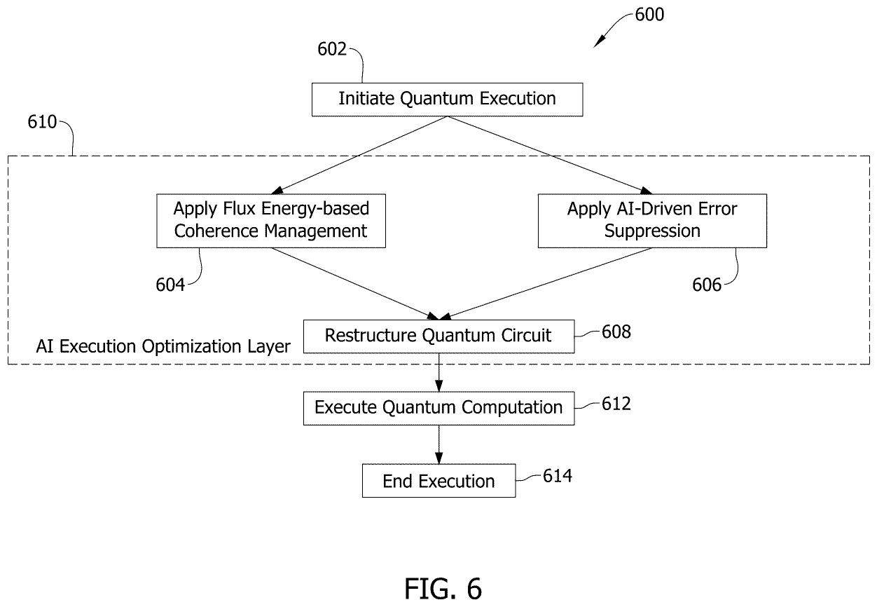

FIG. 6 is a flow diagram of an example method 600 of operating a quantum computing system with the architecture 500 shown in FIG. 5. In the method 600, the quantum computing system initiates 602 a quantum execution using a quantum circuit(s). The system manages 604 flux energy-based coherence modulation. For example, the system determines and adjusts execution pathways based on flux coherence fields of the qubits to manipulate interactions and facilitate attaining and maintaining coherence of the qubits. The system detects potential decoherence in real-time during operation of the system and/or predicts potential decoherence based on pre-operation modeling and adjusts operation to prevent the decoherence.

The system applies 606 AI-driven error suppression to determine executions that reduce errors in the quantum operations. For example, the system determines and adjusts execution pathways based on flux coherence fields of the qubits to manipulate interactions and reduce errors of quantum calculations.

The system restructures 608 the quantum circuit. For example, the executions from the field-based coherence modulation and the AI-driven error suppression are combined and optimal executions are determined to perform the quantum operations. The executions include timing and operation of gates for qubits in the quantum circuit or other operating parameters of the quantum circuit. The instructions for timing and operations are stored on a memory for performing the quantum operation. In some examples, the system restructures 608 the quantum circuit in real-time by sending commands directly to the gates at the time the gates are required to operate. The real-time operation may reduce processing requirements and improve the accuracy of the information and predictions of the architecture because the architecture is utilizing current information. In addition, the architecture reduces the propagation of errors because the architecture suppresses the errors before the errors occur or immediately at the time that any errors do occur.

For example, an AI execution optimization layer 610 encompasses and performs the flux energy-based coherence modulation, the AI-driven error suppression, and the quantum circuit restructuring. The AI execution optimization layer 610 uses generative artificial intelligence to model the flux fields and provide AI-driven execution restructuring of the quantum circuit.

The system executes 612 the quantum computation via the restructured quantum circuit. For example, the gates are operated with a timing to transform the qubits along executions pathways determined or modified based on the field-based coherence modulation and the AI-driven error suppression. The quantum circuit operates to execute the quantum computations quicker and with reduced errors because the system is structured or restructured using the flux coherence fields.

The system ends 614 the execution when the quantum computations are completed.

The steps of the method 600, or other methods described herein, are presented in an ordered combination that provides advantages in some examples. In other examples, the steps of the method 600, or other methods described herein, may be repeated any number of times and in different orders or combinations.

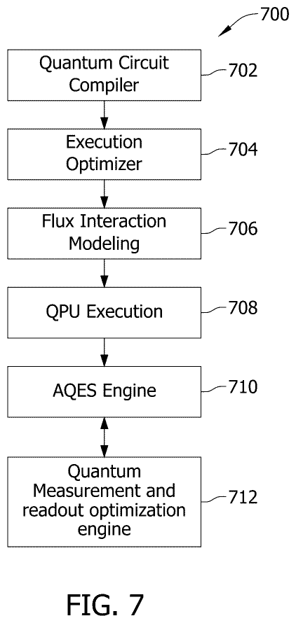

FIG. 7 is a schematic diagram of a software-driven quantum execution framework 700 of an example quantum computing system. The framework 700 includes a quantum circuit compiler 702 and a dynamic execution optimizer 704. The quantum circuit compiler 702 prepares quantum circuits for optimized execution. The dynamic execution optimizer 704 adjusts qubit interactions and coherence stability based on modeling by a generative artificial intelligence system.

The framework 700 includes a flux interaction modeling module 706 that is software-based. For example, the flux interaction modeling module 706 implements dynamic execution by modifying execution timing. In the example, the flux interaction modeling module 706 does not require hardware resonance. The flux interaction modeling module 706 applies structured vacuum energy principles and/or the flux fields of the qubits to determine the executions. The structured vacuum energy principles provide a model of how the qubits interact with forces such as gravitational fields within the vacuum environment around the qubits. The flux interaction modeling module 706 models the fields around the qubits and determines effects of projected structured vacuum energy and/or flux interactions. The flux interaction modeling module 706 can predict and manipulate the interactions to determine the dynamic execution of the circuit.

Optionally, the framework 700 includes a multi-QPU execution module 708 that interfaces across multiple quantum processors. For example, the multi-QPU execution module 708 distributes qubits dynamically across multiple quantum processors via software.

The framework 700 includes an adaptive quantum error suppression (AQES) engine 710 and a quantum measurement and readout optimization engine 712. The AQES engine 710 identifies and corrects quantum errors before execution errors propagate. In some examples, the AQES engine 710 dynamically influences measurement accuracy and information is continually shared and adjusted between the AQES engine 710 and the quantum measurement and readout optimization engine 712. The quantum measurement and readout optimization engine 712 is configured to deliver noise reduction, enhanced readout accuracy, and/or post-processing of results. The quantum measurement and readout optimization engine 712 ensures final quantum state measurements are accurate and reduces readout errors. The measurement optimizations may occur before execution, during runtime, and/or after results are collected.

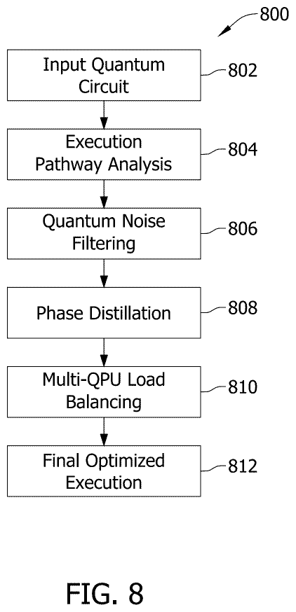

FIG. 8 is a flow diagram of an example method 800 of dynamically adjusting a quantum circuit execution to, for example, optimize stability, coherence, and efficiency. The method 800 includes inputting 802 a quantum circuit. For example, the quantum circuit is a user-designed or selected circuit that is input for optimization. The method 800 utilizes a generative artificial intelligence to optimize the circuit. Accordingly, the generative artificial intelligence performs at least some of the steps in the example.

The generative artificial intelligence executes 804 a pathway analysis. For example, the generative artificial intelligence evaluates circuit depth, coherence risks, and error-prone gates.

Also, the generative artificial intelligence filters 806 quantum noise. For example, the generative artificial intelligence applies AI-based noise suppression strategies.

In addition, the system performs phase distillation and coherence correction 808 to ensure phase consistency across qubits and, optionally, multi-QPU load balancing 810 if needed to distribute execution across multiple QPUs.

The generative artificial intelligence delivers a final optimized circuit 812. For example, the final optimized circuit 812 is ready for execution of quantum operations.

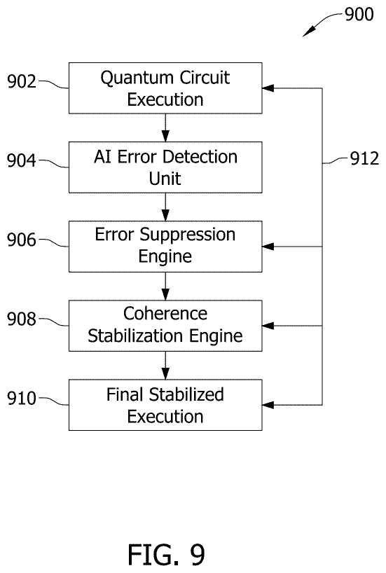

FIG. 9 is a flow diagram of an example quantum error suppression and coherence stabilization module 900. The module 900 provides adaptive quantum error suppression and quantum coherence self-regulation to prevent decoherence without requiring extra or redundant qubits for error correction.

The module 900 includes a quantum circuit execution 902, an AI error detection unit 904, an error suppression engine 906, a coherence stabilization engine 908, and a final stabilized execution 910.

The AI error detection unit 904 utilizes artificial intelligence and monitors for potential decoherence. For example, the AI error detection unit generates models of the qubits and determines issues that may cause decoherence based on the models. The error suppression engine 906 receives the detected errors from the AI error detection unit 904 and applies real-time corrections using quantum error correction.

The coherence stabilization engine 908 provides coherence self-regulation of the quantum circuit. For example, the coherence stabilization engine 908 adjusts execution timing of the quantum circuit dynamically to ensure coherence of the qubits. The adjusted timings are outputted for the final stabilized execution 910.

The final stabilized execution 910 is the stabilized quantum execution which is output from the AI error detection unit 904, the error suppression engine 906, and the coherence stabilization engine 908. The final stabilized execution 910 provides a final corrected quantum state for the quantum circuit execution 902. The final stabilized execution 910 has at least one operating parameter (e.g., an execution timing) that has been changed from the initial version of the quantum circuit execution 902. Suitably, the module 900 is configured to provide the final stabilized execution 910 that has an improved coherence of the qubits and an increased stability of the qubits.

Also, in the example, the module 900 includes continuous feedback loops 912. The continuous feedback loops 912 may include generative AI that continually monitors and learns from execution errors. Accordingly, after or during execution, the final stabilized execution 910 or information from the final stabilized execution 910 is provided to the error suppression engine 906 and/or the coherence stabilization engine 908 for continued refinement.

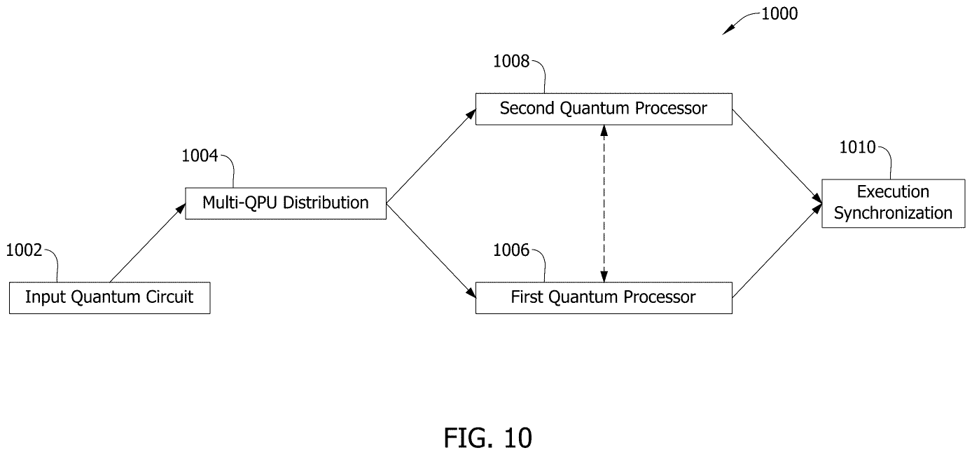

FIG. 10 is a schematic diagram of a system architecture 1000 including multiple quantum processors. The system architecture 1000 provides virtualization for distributed quantum processing and executes circuits across multiple quantum processors using software-defined load balancing.

The system architecture 1000 includes at least one input quantum circuit 1002 and a multi-QPU distribution unit 1004. The multi-QPU distribution unit 1004 receives the quantum circuit and distributes the execution of the input quantum circuit 1002. For example, the multi-QPU distribution unit 1004 determines loading due to timing of gates and/or execution operations on qubits by the input quantum circuit 1002 and assigns the executions to achieve a leveling of the load and/or based on different capacities of the QPUs.

The multi-QPU distribution unit 1004 distributes executions from the input quantum circuit 1002 to a first quantum processor 1006 and a second quantum processor 1008. The first quantum processor 1006 and the second quantum processor 1008 are configured to perform the executions of the input quantum circuit 1002 simultaneously.

The first quantum processor 1006 and the second quantum processor 1008 output results from the executions of the input quantum circuit 1002. The results are synchronized and merged to produce a final execution synchronization 1010.

In some examples, the system architecture 1000 maintains quantum coherence and preserves real-time entanglement fidelity across the first quantum processor 1006 and the second quantum processor 1008. In further examples, the system architecture 1000 asynchronously manages batch execution across the first quantum processor 1006 and the second quantum processor 1008 and does not necessarily maintain quantum coherence between the first quantum processor 1006 and the second quantum processor 1008.

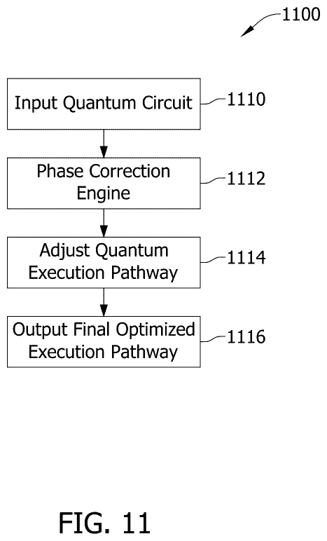

FIG. 11 is a flow diagram of an example method 1100 of operating a quantum circuit using phase distillation and AI-controlled execution pathway optimization. The method 1100 corrects phase inconsistencies and dynamically optimizes execution pathways of the quantum circuit.

The method 1100 includes inputting 1110 a quantum circuit. For example, the quantum circuit may be designed by a user using a program on a computing device and the computing device may transmit the circuit design to the phase distillation and AI-controlled execution pathway optimizer. Alternatively, the initial circuit design may be retrieved from a database of circuits or generated using look-up tables or standardized circuit design principles. Accordingly, the quantum circuit may include phase instabilities introduced during the design process and/or inherent in traditional circuit designs. For example, the phase instabilities may be due to interactions between the qubits and/or due to flux interference during operation of the quantum gates.

The method 1100 includes correcting 1112 the phase of qubits of the quantum circuit using a phase correction engine. For example, the phase correction engine realigns phase interactions of the qubits during execution of the circuit. The phase interactions are realigned to ensure that the qubits are maintained in desired operating states throughout execution of the circuit. The phase correction engine eliminates or reduces phase interactions that could induce instability of the qubits and introduce potential for errors.

Also, the method 1100 includes adjusting 1114 a quantum execution pathway. The gate operations of the quantum circuit are rearranged for efficiency and to optimize the execution pathway of the quantum circuit. For example, the gate operations are determined to reduce the effect of flux noise on the qubits based on the flux coherence fields of the qubits.

In some examples, the phase corrections and the optimized execution pathways are determined and applied during a transpilation process as the circuit is translated between programming code.

The phase corrections and the optimized execution pathways are combined to output 1116 a final optimized execution pathway. For example, the phase corrections and the pathway realignments are applied to the input quantum circuit to provide a final quantum circuit for execution. In some examples, the phase corrections and the optimized execution pathways are provided as annotations and/or directives to change the input circuit. The output 1116 incorporates the annotations and/or directives into a final executable version that is configured to be transmitted or read for operation of the quantum circuit. An example output circuit diagram is shown in FIG. 12.

FIG. 12 is a schematic diagram of a portion of an example quantum circuit 1200. The circuit 1200 includes a first qubit 1202, a second qubit 1204, a third qubit 1206, a fourth qubit 1208, and a fifth qubit 1210. The qubits 1202, 1204, 1206, 1208, 1210 are acted upon by gates on execution pathways. Example gates include RZ(θ) gates, RX(θ) gates, U3(θ, ¢, λ) gates, Hadamard (H) gates, controlled-X gates, and RZX(θ) gates.

The RZ(θ) gate rotates a qubit around the Z-axis of the Bloch sphere by an angle θ. When executed, the RZ(θ) gate leaves the X and Y coordinates unchanged. In addition, the RZ(θ) gate changes phase information without affecting measurement probabilities in the computational basis.

The RX(θ) gate rotates a qubit around the X-axis of the Bloch sphere by an angle θ. The RX(θ) gate can move a qubit between the poles of the Bloch sphere. The RX(θ) gate effects probability amplitudes in addition to phase. The RX(θ) gate is used in qubit flipping operations because the RX(θ) gate can map a first state (e.g., state |0>) to a superposition or to a second state (e.g., state |1>). The RX(θ) gate provides for single-qubit state preparation.

The U3(θ, φ, λ) gate is a single-qubit rotation that allows rotation around all three Bloch sphere axes (X, Y, Z). The U3 gate can express any single-qubit unitary transformation and is a generalized form of RX, RY, and RZ gates. For example, the U3 gate is used when fine-tuned qubit state preparation is needed.

The Hadamard (H) gate creates equal superposition by rotating qubits 45° about the X+Z axis. The H gate transforms computational basis states.

The CNOT (e.g., controlled-X/XOR Gates) is a two-qubit gate where one qubit (control) determines the flipping of another qubit (target). A CNOT gate is used for quantum entanglement and error correction. If the control qubit is in a second state (e.g., state |1>), the target qubit flips between the first state (e.g., state |0>) and the second state (e.g., state |1>).

The RZX(θ) gate is a two-qubit controlled rotation gate. The RZX(θ) gate applies an RX(θ) rotation on the target qubit controlled by the state of the first qubit. The RZX(θ) gate is used to optimize quantum state synchronization and coherence adjustments.

Measurement and final readout is provided by a measurement operator represented by (M) in the quantum circuit 1200. The measurement operator collapses quantum states into classical bits (e.g., “0”s and “1”s), and ensures the final computational result is extracted after all optimizations.

During operation of the quantum circuit 1200, a first layer 1212 includes quantum state initialization. In the first layer 1212, Hadamard gates (H) are applied to the qubits 1202, 1204, 1206, 1208, 1210 to place the qubits 1202, 1204, 1206, 1208, 1210 in superposition for parallel execution.

A second layer 1214 applies phase and coherence optimizations. For example, RZ(θ), RX(θ), and U3 gates apply dynamic phase and coherence adjustments. The operations stabilize quantum entanglement before entangling operations.

A third layer 1216 includes entanglement and execution pathway optimizations. In the third layer 1216, the controlled-X (CNOT) and RZX(θ) gates generate multi-qubit correlations. Also, dynamic RX and RZ adjustments refine the execution pathway.

A fourth layer 1218 includes readout and phase correction. In the fourth layer 1218, the RX gates are used to provide rotations and adjust the qubits 1202, 1204, 1206, 1208, 1210 before measurement. The qubits 1202, 1204, 1206, 1208, 1210 are measured (M) to extract final results.

While the illustrated example shows gates in specific layers, this is for illustrative purposes and does not limit the arrangement of the gates. In some examples the gates may be included in different layers or arranged in any manner. For example, the gates may be rearranged dynamically to improve performance of the circuit 1200 based on feedback during operation of the circuit 1200.

The circuit 1200 uses AI-driven RX and RZ phase optimizations instead of traditional error-correction redundancy. The circuit 1200 is compatible with multi-QPU execution due to software-controlled RZX entanglement structure. Also, no additional qubits are required because the circuit 1200 utilizes software-defined execution to stabilize coherence. The final measurements are outputted and verified to ensure that the optimizations improve computational accuracy.

FIG. 13 is a block diagram of an example integration of a qubit flux field stabilization engine 1300. The qubit flux field stabilization engine 1300 is incorporated into middleware that facilitates communication between an operating system 1302 and an application 1304. For example, the application 1304 is an API-driven quantum execution layer.

The qubit flux field stabilization engine 1300 interacts with a quantum library 1306 to provide quantum state control. The quantum library may be any standard commercial libraries and/or custom libraries. The quantum library can include machine instructions such as, for example and without limitation, calibration procedures, hardware tests, quantum algorithms, quantum gates, etc. For example, the qubit flux field stabilization engine 1300 reads or extracts commands, quantum executions, and/or quantum information from the quantum library 1306.

During operation, the qubit flux field stabilization engine 1300 acts as an interface between the operating system 1302 and the application 1304. For example, the qubit flux field stabilization engine 1300 communicates with the application 1304 using directives or abstractions to simplify the processing of the application 1304 and translates the directives into commands and data that enable the operating system to implement the directives. The qubit flux field stabilization engine 1300 communicates with the quantum library 1306 to provide information or retrieve quantum executions. In addition, the qubit flux field stabilization engine 1300 may provide authentication and other functions. The qubit flux field stabilization engine 1300 facilitates scalability of the system because the qubit flux field stabilization engine 1300 is able to interact with any platform.

In the example, while interacting with the operating system 1302 and the application 1304, the qubit flux field stabilization engine 1300 determines and/or rearranges quantum execution operations to reduce errors, enhance entanglement, and stabilize coherence of the qubits. For example, the qubit flux field stabilization engine 1300 receives directives from the application relating to a quantum operation to be performed and/or an initial quantum execution. The qubit flux field stabilization engine 1300 performs AI error detection to correct quantum execution, adjusts coherence stabilization dynamically based on modeled qubit flux fields, and provides circuit-level optimization without modifying physical qubits. The qubit flux field stabilization engine 1300 provides a final quantum execution to the operating system 1302 for operation and receives continuous feedback during operation to monitor and dynamically adapt the real-time operation.

### Models

Models may be implemented by any of the systems, engines, modules, or components described above to improve performance of quantum computing systems.

In one model, a quantum circuit includes at least two gates (e.g., controlled-Z gates) that are implemented via flux tuning to stabilize qubits according to a stabilization module. The stabilization module applies a compensating drive or bias based on the determined flux fields and interactions during, for example, gate operations. In conventional structures, operations of the gates momentarily move qubits away from a stabilized point and expose the qubits to noise. In the described model, during a gate operation, a compensating drive or bias is applied to the qubits to effectively cancel or offset the noise. In one example, if two qubits must be tuned into resonance for a SWAP operation, the stabilization module applies an opposite signed flux bias to a neighboring coupler circuit that has the effect of locally canceling out low-frequency flux noise in the operated qubits. The opposing field is determined to keep the net field seen by the qubit stable.

In another model, the qubit frequency during operation of a gate depends on a control parameter x(t) (which could be flux). The circuit has an ideal control of x0(t) set for the gate, but a noise n(t) can affect the qubit operated on by the gate. The resulting operation is shown by equation (3).

$$x ( t ) = x 0 ( t ) + η ( t ) \qquad Eq ( 3 )$$

The gate error phase φ acquired due to this noise can be approximated by equation (4).

$$ϕ \approx \int ( \partial ω / \partial x ) η ( t ) dt \qquad Eq ( 4 )$$

If ∂ω/∂x is nonzero during the gate operation, noise will cause an effect on the qubit and could lead to instability. The model determines and introduces an auxiliary control y(t) to reduce the total phase sensitivity to be approximately zero for low-frequency components.

Some models utilize monopole-based stabilization to provide an advanced layer of error suppression and facilitate the operational point or paths of qubits and gates being noise-insensitive. The models reduce the reliance on detecting and correcting errors after they occur because the model facilitates preventing or canceling those errors in real-time. The models reduce or eliminate control-induced and low-frequency noise errors.

In one model, a two-qubit CZ gate is implemented by tuning the qubit frequency. Prior to or during implementation of the gate, the model schedules a compensating detuning on a spectator qubit or a coupler that produces an opposite-phase error, canceling the noise to first order. The noise is modeled as if the noise were emanating from a fictitious monopole and the model designs a symmetric response to nullify the effect of the noise.

Models such as those relying on monopoles do not necessarily require the model to determine a flux field for each qubit and can instead rely simply on projected flux interactions. For example, the model can use flux principles and a fictious monopole to model interactions without necessarily determining fields for each qubit. The modeled interactions are then used to adjust operating parameters of the quantum circuit.

In yet another model, the stabilization module in a trapped-ion system could use an auxiliary field mode to stabilize the phase reference of ions such that optical phase noise affects both ions equally and cancels the differential phase.

In photonic qubits, a model uses, for example, symmetric interference such that loss or phase noise occurs equally in two paths, yielding a robust logical encoding (e.g., dual-rail photonic qubits with balanced loss).

### Test Results:

Simulated models of examples quantum circuits using the described techniques were tested in a series of simulations modeling real world noise environments in superconducting and trapped-ion systems.

In one test, a single superconducting qubit simulated under a standard 1/f noise model had a baseline coherence time of 20 μs. With the described systems and methods, the effective coherence time was extended to approximately 120 μs.

In addition, multiple modeled qubit circuits had a GHZ fidelity that increased from 78% in baseline to 94% when optimized by the described systems and methods in the modeled circuits. The quantum Fourier transform success probability increased from 60% to 85%, and the random circuit total variation distance was reduced from 0.25 to 0.12 for the circuits utilizing the described systems and methods in comparison to conventional systems and methods.

Also, models of multiple qubit processing units (multi-QPUs) were tested and compared to benchmarks. A distributed simulation using a 5-qubit superconducting processor and a 3-qubit trapped-ion system was performed. In the simulation, a distributed Grover's search algorithm achieved an 8-qubit success probability of 70% (compared to 12.5% without coordinated entanglement). The quantum teleportation protocol between QPUs reached a fidelity of 96%. Accordingly, the systems and methods provide a bridge for different hardware platforms with less performance degradation than other systems and methods.

### NUMBERED EXAMPLES

Example 1. A quantum processor comprising: a quantum circuit including qubits; and a qubit flux field stabilization engine configured to: model a flux coherence field for each qubit; and adjust at least one parameter of the quantum circuit based on the flux coherence fields around the qubits to at least one of reduce interference among the flux coherence fields, reduce noise, or reduce power consumption of the quantum processor.

Example 2. A quantum processor in accordance with example 1, wherein the qubit flux field stabilization engine is configured to determine a predicted operating status of the qubits and adjust at least one operating parameter of the quantum circuit based on the predicted operating status of the qubit.

Example 3. A quantum processor in accordance with example 2, wherein the predicted operating status of the qubits relates to at least one of a decoherence, a quantum error rate, or quantum noise.

Example 4. A quantum processor in accordance with example 1, further comprising quantum gates that perform transformations on the qubits, and wherein the qubit flux field stabilization engine is configured to selectively adjust timing of the gates based on modeled flux energy coherence.

Example 5. A quantum processor in accordance with example 4, wherein the qubit flux field stabilization engine is configured to determine a timing of the quantum gates to reduce interference between the flux coherence fields of the qubits.

Example 6. A quantum processor in accordance with example 1, wherein the qubit flux field stabilization engine is configured to: model interactions in the flux coherence fields around the qubits; and modify execution-layer qubit coherence interactions based on Artificial Intelligence based modeling of the execution-layer qubit coherence interactions.

Example 7. A quantum processor in accordance with example 1, wherein the qubit flux field stabilization engine includes a generative artificial intelligence that is configured to predict a potential quantum error and adjust at least one operating parameter of the quantum processor to reduce an opportunity for the quantum error to occur.

Example 8. A quantum processor in accordance with example 1, wherein the qubit flux field stabilization engine is configured to: predict decoherence of at least one qubit in real-time based on fluctuations in the flux coherence fields; and modulate the flux coherence fields based on the predicted decoherence to reduce an opportunity for the decoherence to occur.

Example 9. A quantum processor in accordance with example 1, wherein the flux coherence field is based on vacuum fluctuations, and the qubit flux field stabilization engine adjusts the parameter to generate structures of the vacuum fluctuations within the flux coherence fields.

Example 10. A quantum processor in accordance with example 8B, wherein the flux coherence fields are modeled based on a calculated effective flux experienced by the qubit, wherein the calculated effective flux is determined by summing a nominal qubit flux bias and weighted external noise sources.

Example 11. A method of operating a quantum processor, the method comprising: initializing a quantum circuit of the quantum processor, the quantum circuit including qubits; determining a flux coherence field for each qubit using a qubit flux field stabilization engine connected to the quantum circuit; modulating at least one parameter of the quantum circuit based on the flux coherence fields around the qubits to at least one of reduce interference among the flux coherence fields, reduce noise, or reduce power consumption of the processor; and performing, using the circuit, a quantum operation.

Example 12. A method in accordance with example 11, further comprising determining a predicted operating status of the qubits based on the flux coherence fields and modulating the at least one operating parameter of the quantum circuit based on the predicted operating status of the qubit.

Example 13. A method in accordance with example 11, wherein the predicted operating status of the qubits relates to at least one of a decoherence, a quantum error rate, or quantum noise.

Example 14. A method in accordance with example 11, further comprising selectively controlling, via the quantum stabilization module, quantum gates that perform transformations on the qubits based on the flux coherence fields around the qubits.

Example 15. A method in accordance with example 14, further comprising determining a timing of the quantum gates to reduce interference between the flux coherence fields of the qubits.

Example 16. A method in accordance with example 11, further comprising: determining interactions between the flux coherence fields around the qubits; and modifying an execution pathway of the quantum circuit to stabilize interactions in the flux coherence field for each qubit.

Example 17. A method in accordance with example 16, further comprising: predicting decoherence of at least one qubit in real-time based on fluctuations in the flux coherence fields; and modulating the flux coherence fields based on the predicted decoherence to reduce an opportunity for the decoherence to occur.

Example 18. A quantum computing system comprising: a first quantum processor comprising a first quantum circuit including first qubits; a second quantum processor comprising a second quantum circuit including second qubits; and a quantum processor synchronization module configured to: model a first flux coherence field for each first qubit; model a second flux coherence field for each second qubit; and synchronize quantum computing operations of the first quantum processor and the second quantum processor based on the first flux coherence fields and the second flux coherence fields.

Example 19. A quantum computing system in accordance with example 18, further comprising a qubit flux field stabilization engine configured to adjust at least one parameter of the first quantum circuit and the second quantum circuit to manipulate an operating status of the first qubits and the second qubits based on the first flux coherence fields and the second flux coherence fields to at least one of reduce interference among the first and second flux coherence fields, reduce noise, or reduce power consumption of the first and second quantum processor.

Example 20. A quantum computing system in accordance with example 19, wherein the quantum processor synchronization module is configured to synchronize the quantum computing operations of the first quantum processor and the second quantum processor based on the at least one parameter adjusted by the qubit flux field stabilization engine.

Example 21. A quantum execution framework that dynamically adjusts coherence states of qubits using software-driven structured flux field modeling.

Example 22. A software-driven quantum error suppression module that dynamically detects and corrects quantum noise before execution errors propagate.

Example 23. A quantum execution method that enables seamless cross-device synchronization of entangled qubits across multiple quantum processors without requiring hardware interconnects.

Example 24. A quantum execution process that continuously monitors and adjusts coherence stability of qubits to prevent decoherence during execution.

Example 25. A software-defined process that refines quantum phase interactions to maintain entanglement fidelity during quantum executions.

Example 26. An AI-driven execution framework that dynamically reorganizes quantum gate operations in real-time to minimize circuit depth and execution latency.

Example 27. An artificial intelligence system that detects and suppresses environmental and computational quantum noise during execution.

Example 28. A quantum execution optimization framework that dynamically restructures execution pathways using AI-driven coherence and phase adjustments.

Example 29. A software-driven execution monitoring system that actively stabilizes quantum state coherence during computation.

Example 30. An AI-enhanced hybrid quantum-classical execution framework that dynamically adjusts computational workload distribution between classical and quantum processors.

Example 31. A software-defined quantum execution framework that dynamically adjusts quantum circuit execution based on structured flux energy modeling, flux stabilization, and qubit-induced coherence control.

Example 32. A software-driven quantum measurement stability system that reduces decoherence effects caused by state collapse during final readout operations.

Example 33. An AI-powered self-calibrating quantum execution system that continuously refines quantum circuit parameters based on real-time execution feedback to improve overall stability.

Example 34. A quantum execution framework that directly interacts with at least one quantum computing library to provide quantum state control.

Example 35. A quantum execution system using generative AI for real-time coherence stabilization and quantum error suppression without hardware modifications, wherein the quantum execution system is configured to restructure quantum execution dynamically based on structured vacuum energy modeling.

Example 36. A self-adaptive quantum circuit transpiler that restructures quantum execution dynamically based on structured vacuum energy modeling

Example 37. A software-defined quantum execution framework designed for multi-platform quantum hardware compatibility without requiring physical modifications to quantum processors.

Example 38. A quantum execution framework that dynamically modifies circuit transpilation and execution pathways via structured vacuum energy modeling and AI-driven error suppression.

Example 39. A quantum flux field engine that continuously refines qubit execution parameters and gate operations based on real-time feedback from structured vacuum field modeling.

Example 40. A quantum processor comprising: a quantum circuit including qubits that are operated according to execution pathways to perform quantum operations; and a qubit flux field stabilization engine configured to: model flux interactions associated with the execution pathways and/or the qubits; and adjust at least one parameter of the quantum circuit based on the flux interactions to at least one of reduce flux interference, reduce noise, or reduce power consumption of the quantum processor.

Example 41. A method of operating a quantum processor, the method comprising: initializing a quantum circuit of the quantum processor, the quantum circuit including qubits that are operated according to execution pathways to perform quantum operations; determining flux interactions associated with the execution pathways and/or the qubits using a qubit flux field stabilization engine; adjusting at least one parameter of the quantum circuit based on the flux interactions to at least one of reduce interference among the flux coherence fields, reduce noise, or reduce power consumption of the processor; and performing, using the quantum circuit, a quantum operation.

Example 42. A quantum computing system comprising: a quantum processor including qubits; and a qubit flux field stabilization engine configured to: model a flux coherence field for each qubit; and adjust at least one parameter of the quantum processor based on the flux coherence fields around the qubits to at least one of reduce interference among the flux coherence fields, reduce noise, or reduce power consumption of the quantum processor.

The described systems and methods provide technical advantages and improve the technology of quantum computing systems. For example, quantum computing systems and methods are described which increase quantum coherence, reduce quantum error rates, and improve power efficiency of quantum computing systems. For example, the described systems and methods include a qubit flux field stabilization engine that adjusts operating parameters of the quantum computing system in real time to manipulate, reduce, or increase the interactions of the flux coherence fields of the qubits and thereby reduce interference among the flux coherence fields, reduce signal noise, and/or reduce power consumption of a quantum processor of the quantum computing system. The described systems and methods are compatible with a broad range of computing architectures including superconducting qubit platforms, quantum processing units, and hybrid quantum-classical computing infrastructure. Also, the described systems and methods may be incorporated into or added to existing quantum computing infrastructures without additional hardware requirements. The described systems and methods increase the quantum capacity of the quantum computing by providing more efficient operation and enhanced capabilities of the quantum processors.

As will be appreciated based on the foregoing specification, the above-described embodiments of the disclosure may be implemented using computer programming or engineering techniques including computer software, firmware, hardware or any combination or subset thereof, wherein the technical effect is to provide enhanced quantum computing. Any such resulting program, having computer-readable code means, may be embodied or provided within one or more computer-readable media, thereby making a computer program product, (i.e., an article of manufacture), according to the discussed embodiments of the disclosure. As used herein, the terms “computer-readable media” or “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the terms “computer-readable media” or “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

When introducing elements of the present disclosure, the articles “a”, “an”, “the” and “the” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

As various changes could be made in the above without departing from the scope of the disclosure, it is intended that all matter contained in the above description and shown in the accompanying drawings shall be interpreted as illustrative and not in a limiting sense.

1. A quantum processor comprising:
a quantum circuit including qubits; and
a qubit flux field stabilization engine configured to:
model a flux coherence field for each qubit; and
adjust at least one parameter of the quantum circuit based on the flux coherence fields around the qubits to at least one of reduce interference among the flux coherence fields, reduce noise, or reduce power consumption of the quantum processor.

2. A quantum processor in accordance with claim 1, wherein the qubit flux field stabilization engine is configured to determine a predicted operating status of the qubits and adjust at least one operating parameter of the quantum circuit based on the predicted operating status of the qubit.

3. A quantum processor in accordance with claim 2, wherein the predicted operating status of the qubits relates to at least one of a decoherence, a quantum error rate, or quantum noise.

4. A quantum processor in accordance with claim 1, further comprising quantum gates that perform transformations on the qubits, and wherein the qubit flux field stabilization engine is configured to selectively adjust timing of the quantum gates based on modeled flux energy coherence.

5. A quantum processor in accordance with claim 4, wherein the qubit flux field stabilization engine is configured to determine a timing of the quantum gates to reduce interference between the flux coherence fields of the qubits.

6. A quantum processor in accordance with claim 1, wherein the qubit flux field stabilization engine is configured to:
model interactions in the flux coherence fields around the qubits; and
modify execution-layer qubit coherence interactions based on Artificial Intelligence based modeling of the execution-layer qubit coherence interactions.

7. A quantum processor in accordance with claim 1, wherein the qubit flux field stabilization engine includes a generative artificial intelligence that is configured to predict a potential quantum error and adjust at least one operating parameter of the quantum processor to reduce an opportunity for the potential quantum error to occur.

8. A quantum processor in accordance with claim 1, wherein the qubit flux field stabilization engine is configured to:
predict decoherence of at least one qubit in real-time based on fluctuations in the flux coherence fields; and
modulate the flux coherence fields based on the predicted decoherence to reduce an opportunity for the decoherence to occur.

9. A quantum processor in accordance with claim 1, wherein the flux coherence field is based on vacuum fluctuations, and the qubit flux field stabilization engine adjusts the parameter to generate structures of the vacuum fluctuations within the flux coherence fields.

10. A quantum processor in accordance with claim 9, wherein the flux coherence fields are modeled based on a calculated effective flux experienced by the qubit, wherein the calculated effective flux is determined by summing a nominal qubit flux bias and weighted external noise sources.

11. A method of operating a quantum processor, the method comprising:
initializing a quantum circuit of the quantum processor, the quantum circuit including qubits;
determining a flux coherence field for each qubit using a qubit flux field stabilization engine connected to the quantum circuit;
adjusting at least one parameter of the quantum circuit based on the flux coherence fields around the qubits to at least one of reduce interference among the flux coherence fields, reduce noise, or reduce power consumption of the processor; and
performing, using the quantum circuit, a quantum operation.

12. A method in accordance with claim 11, further comprising determining a predicted operating status of the qubits based on the flux coherence fields and modulating the at least one operating parameter of the quantum circuit based on the predicted operating status of the qubit.

13. A method in accordance with claim 12, wherein the predicted operating status of the qubits relates to at least one of a decoherence, a quantum error rate, or quantum noise.

14. A method in accordance with claim 11, further comprising selectively controlling, via the qubit flux field stabilization engine, quantum gates that perform transformations on the qubits based on the flux coherence fields around the qubits.

15. A method in accordance with claim 14, further comprising determining a timing of the quantum gates to reduce interference between the flux coherence fields of the qubits.

16. A method in accordance with claim 11, further comprising:
determining interactions between the flux coherence fields around the qubits; and
modifying an execution pathway of the quantum circuit to stabilize interactions in the flux coherence field for each qubit.

17. A method in accordance with claim 16, further comprising:
predicting decoherence of at least one qubit in real-time based on fluctuations in the flux coherence fields; and
modulating the flux coherence fields based on the predicted decoherence to reduce an opportunity for the decoherence to occur.

18. A quantum computing system comprising:
a first quantum processor comprising a first quantum circuit including first qubits;
a second quantum processor comprising a second quantum circuit including second qubits; and
a quantum processor synchronization module configured to:
model a first flux coherence field for each first qubit;
model a second flux coherence field for each second qubit; and
synchronize quantum computing operations of the first quantum processor and the second quantum processor based on the first flux coherence fields and the second flux coherence fields.

19. A quantum computing system in accordance with claim 18, further comprising a qubit flux field stabilization engine configured to adjust at least one parameter of the first quantum circuit and the second quantum circuit to manipulate an operating status of the first qubits and the second qubits based on the first flux coherence fields and the second flux coherence fields to at least one of reduce interference among the first and second flux coherence fields, reduce noise, or reduce power consumption of the first and second quantum processor.

20. A quantum computing system in accordance with claim 19, wherein the quantum processor synchronization module is configured to synchronize the quantum computing operations of the first quantum processor and the second quantum processor based on the at least one parameter adjusted by the qubit flux field stabilization engine.

21-42. (canceled)
